(19) United States
(12) Patent Application Publication
(10) Pub. No.: US 2018/0177326 A1
(43) Pub. Date: Jun. 28, 2018

(54) FLASH BREWER

(71) Applicant: FourBarrel Coffee, San Francisco, CA (US)

(72) Inventors: Jeremy TOOKER, San Francisco, CA (US); Brett WHITMAN, San Francisco, CA (US); Tal MOR, San Francisco, CA (US)

(21) Appl. No.: 15/847,640

(22) Filed: Dec. 19, 2017

Related U.S. Application Data
(60) Provisional application No. 62/438,431, filed on Dec. 22, 2016.

(51) Int. Cl. A47J 31/10; A47J 31/50

(52) U.S. Cl. CPC A47J 31/10; A47J 31/50

(57) ABSTRACT

A flash brewer includes an insulated container, a liquid inlet, a liquid flow assembly, a cooling assembly, and a liquid outlet. The insulated container thermally insulates interior of the insulated container from an exterior environment. The liquid inlet is coupled to the insulated container and receives a liquid, e.g., coffee, to be chilled. The liquid flow assembly is housed within the insulated container and receives the liquid to be chilled from the liquid inlet and to flow the liquid to be chilled. The cooling assembly is housed within the insulated container and flows coolant composition within the cooling assembly. The cooling assembly is thermally coupled to the liquid flow assembly facilitating a heat exchange between the liquid to be chilled and the coolant composition. The liquid outlet is coupled to the insulated container and outputs the chilled liquid to the exterior environment of the insulated container.

### RELATED APPLICATION

The instant application is a non-provisional U.S. patent application that claims the benefit and priority to the Provisional Patent Application No. 62/438,431, that was filed on Dec. 22, 2016, which is incorporated herein by reference in its entirety.

### BACKGROUND

Apparatuses for brewing coffee are well known in the art. In the known art, coffee is customarily drip-brewed using heated water. Water is heated in a vessel, and then poured over a container of ground coffee. As the water mingles with the grounds, a coffee extract is produced which drips through a filter into a coffee pot or cup. Improvements to the art have led to machines that automatically heat water and brew coffee in one self-contained device.

Although coffee is traditionally brewed in hot or boiling water, in particular on hot days, cold coffee is preferred. To obtain cold coffee, typically, hot brewed coffee is allowed to cool over a long period of time in the surrounding air, of leaving it for a somewhat shorter time in a refrigerator.

Although coffee is traditionally brewed in hot or boiling water, it is also possible to cold brew coffee. A preference for cold brewed coffee has developed, principally due to its flavor. Since many of the bitter oils and acids contained in coffee are soluble only at high temperature, coffee brewed with hot or boiling water is characterized by a harsh acrid taste. Cold brewed coffee avoids this problem.

One known option for preparing a cold coffee-based beverage is the preparation of a specialty coffee, preferably an espresso, with the aid of a piston-type machine and subsequently pouring it over ice cubes. This type of preparation is characterized by the combination of ice cubes with a smaller amount of coffee, wherein the special drinking experience above all is based on the existing, non-melted ice. With a different method for preparing a cold coffee-based beverage, for example, regular filtered coffee is produced with a filter coffee machine and is then filled into containers in which it is allowed to cool down to room temperature over a longer period of time. The coffee cooled down in this way is then removed from the containers and, if applicable, is served while filled with ice. These types of beverages, however, are no longer fresh at the time when they are dispensed because of the relatively long cooling down period. As the preference for cold brewed coffee has grown, several developments in the cold brew process have been made.

### SUMMARY

Accordingly, a need has arisen to chill brewed coffee in a more time efficient manner with minimal impact on its flavor. A system for chilling liquid includes an insulated container, a liquid inlet, a liquid flow assembly, a cooling assembly, and a liquid outlet. The insulated container is configured to thermally insulate interior of the insulated container from an exterior environment of the insulated container. The liquid inlet is coupled to the insulated container. The liquid inlet is configured to receive a liquid, e.g., coffee, to be chilled. The liquid flow assembly is housed within the insulated container. The liquid flow assembly is configured to receive the liquid to be chilled from the liquid inlet and to flow the liquid to be chilled. The cooling assembly is housed within the insulated container. The cooling assembly is configured to flow coolant composition within the cooling assembly. The cooling assembly is thermally coupled to the liquid flow assembly facilitating a heat exchange between the liquid to be chilled and the coolant composition. The liquid outlet is coupled to the insulated container. The liquid outlet is configured to output the chilled liquid to the exterior environment of the insulated container.

It is appreciated that in some embodiments, the liquid to be chilled is chilled within a single pass through the liquid flow assembly. Furthermore, in some embodiments, the liquid to be chilled is coffee and the coolant composition may be a glycol compound, a glycol ether, glycerin, liquid nitrogen, a freon refrigerant, or a chlorofluorocarbon compound, for instance. In some embodiments, the liquid flow assembly and the cooling assembly are shaped as a coil where the liquid flow assembly is positioned in close proximity to the cooling assembly to facilitate heat exchange between the liquid to be chilled and the coolant composition.

In some embodiments, the system may further include a coolant delivery device configured to cool the coolant composition after being heated due to heat exchange with the liquid to be chilled. The coolant delivery device may be a glycol chiller, a device configured to house dry ice, a liquid nitrogen cooling device, a coil ice bath, a coil glycol bath, a frame-and-plate heat exchange device, or a heat transfer water reclamation device, to name a few. It is appreciated that in some embodiments, the system may further include a cooling assembly inlet and a cooling assembly outlet. The cooling assembly inlet may be coupled to the cooling assembly. The cooling assembly inlet may be configure to receive the coolant composition from the coolant delivery device external to the insulated container. The cooling assembly outlet may be coupled to the cooling assembly. The cooling assembly outlet may be configured to output the coolant composition to the coolant delivery device. The coolant composition at the cooling assembly inlet is at a lower temperature than the cooling assembly outlet.

According to some embodiments, the system may further include a liquid inlet and a liquid outlet. The liquid inlet may be coupled to the insulated container configured to receive another liquid, e.g., water, that maintains substantially constant temperature within the insulated container. The liquid flow assembly and the cooling assembly are submerged within the another liquid. The liquid outlet may be coupled to the insulated container configured to output the another liquid. The another liquid output from the liquid outlet is heated or cooled to the substantially constant temperature before the liquid inlet receives the another liquid that is at substantially constant temperature. It is appreciated that in some embodiments, the system may further include a stirrer configured to stir the another liquid within the insulated container to maintain a homogeneous temperature throughout the insulated container.

The system in some embodiments may further include a collection container coupled to the liquid outlet. The collection container may be configured to collect the chilled liquid. The collection container is further configured to create a vacuum for enabling the liquid to be chilled to flow through the liquid flow assembly.

These and other features and advantages will be apparent from a reading of the following detailed description.

### BRIEF DESCRIPTION OF THE DRAWINGS

FIG. 1 shows a flash brewer in accordance with some embodiments.

FIGS. 2 and 3 show the chilling container in accordance with some embodiments.

FIG. 4 shows another flash brewer in accordance with some embodiments.

FIGS. 5A and 5B show a flash brewer with frame-and-plate heat exchange device in accordance with some embodiments.

FIGS. 6A-6D show heat exchange devices in accordance with some embodiments.

FIG. 7 shows functional and performance parameters and technical data of a frame- and plate heat exchange device in accordance with some embodiments.

FIG. 8 shows design details and dimensions of a frame-and plate heat exchange device in accordance with some embodiments.

FIGS. 9A-9C show a heat exchange device in accordance with alternative embodiments.

FIG. 10 shows a flash brewer in accordance with alternative embodiments.

FIG. 11 shows a single cup flash brewer in accordance with some embodiments.

### DETAILED DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Throughout the present specification and the accompanying claims the words “comprise,” “include,” and “have” and variations thereof such as “comprises,” “comprising,” “includes,” “including,” “has,” and “having” are to be interpreted inclusively. That is, these words are intended to convey the possible inclusion of other elements or integers not specifically recited, where the context allows. The term “consisting essentially of” means that the composition, method or structure may include additional ingredients, steps and/or parts, but only if the additional ingredients, steps and/or parts do not materially alter the basic and novel characteristics of the claimed composition, method or structure. No language in the specification should be construed as indicating any non-claimed element essential to the practice of the invention.

The terms “a” and “an” and “the” and similar referents used in the context of describing the invention (especially in the context of the following claims) are to be construed to cover both the singular and the plural, unless otherwise indicated herein or clearly contradicted by context.

The term “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Recitation of ranges of values herein are merely intended to serve as a shorthand method of referring individually to each separate value falling within the range, unless otherwise indicated herein, each individual value is incorporated into the specification as if it were individually recited herein. Ranges may be expressed herein as from “about” (or “approximate”) one particular value, and/or to “about” (or “approximate”) another particular value. When such a range is expressed, another embodiment includes from the one particular value and/or to the other particular value. Similarly, when values are expressed as approximations, by use of the antecedent “about” or “approximate” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that is “less than or equal to the value” or “greater than or equal to the value” possible ranges between these values are also disclosed, as appropriately understood by the skilled artisan. For example, if the value “10” is disclosed the “less than or equal to 10” as well as “greater than or equal to 10” is also disclosed.

All methods described herein can be performed in any suitable order unless otherwise indicated herein or otherwise clearly contradicted by context. Further, all methods described herein and having more than one step can be performed by more than one person or entity. Thus, a person or an entity can perform step (a) of a method, another person or another entity can perform step (b) of the method, and a yet another person or a yet another entity can perform step (c) of the method, etc. The use of any and all examples, or exemplary language (e.g., “such as,” or “e.g.,” or “for example”) provided herein is intended merely to better illuminate the invention and does not pose a limitation on the scope of the invention otherwise claimed.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

The headings used herein are for organizational purposes only and are not meant to be used to limit the scope of the description or the claims, which can be had by reference to the specification as a whole. Accordingly, the terms defined immediately below are more fully defined by reference to the specification in its entirety.

Illustrations are for the purpose of describing the embodiments and should not be construed as limiting the scope of the embodiments.

Unless defined otherwise, all technical and scientific terms used herein have the meaning commonly understood by a person skilled in the art to which this invention belongs. As used herein, the following terms have the meanings ascribed to them unless specified otherwise.

As used herein, the term “about” refers to a range of values of plus or minus 10% of a specified value. For example, the phrase “about 200” includes plus or minus 10% of 200, or from 180 to 220, unless clearly contradicted by context.

As used herein, the terms “connect to,” connected to,” “attach to” or “attached to” or grammatical equivalents thereof mean to operatively fasten on, to operatively fasten together, to operatively affix to, to operatively mount to, to operatively mount on, to operatively connect to, to operatively join, to operatively position onto, to operatively position into, to operatively place onto, or to operatively place into as understood in the context presented. “Attachment” means the act of attaching or the condition of being attached. Attachment can be direct or indirectly. For example a part A may be attached directly to part B. Alternatively, part A may be attached indirectly to part B through first attaching part A to part C and then attaching part C to part B. More than one intermediary part can be used to attach part A to part B. Attaching can be permanent, temporarily, or for a prolonged time. For example, an insulated container of the present invention may be attached to a coolant delivery device or a circulation pump temporarily for the time necessary to perform a method of the invention. Alternatively, an insulated container of the present invention may be attached to a coolant delivery device or a circulation pump for a prolonged time, e.g., also when a method of the present invention is not performed.

As used herein, the term “container” refers to a container useful to or configured to collect or house a liquid and includes a vessel, a tank, a bottle, a flask, a bowl, a vat, a silo, a barrel, a keg and the like.

As used herein, the term “operatively” refers to being adapted or configured to perform a function or to permit to perform a function as determined by the context herein. For example, a tubing may be operatively connected to an inlet or to an outlet (or to another part as described herein) so that a liquid flowing or passing through the tubing can also flow or pass through the inlet or through the outlet (or through another part as described herein). In other word, the tubing is connected in a fluid-conducting manner to the inlet or to the outlet (or to the other part as described herein). Being connected in a fluid-connecting manner may comprise one or more additional intermediate elements being optionally arranged in a flow path.

As used herein, the terms “optional” or “optionally” as used throughout the specification means that the subsequently described event or circumstance may but need not occur, and that the description includes instances where the event or circumstance occurs and instances in which it does not. The terms also refer to a subsequently described composition that may but need not be present, and that the description includes instances where the composition is present and instances in which the composition is not present.

As used herein, the term “portable” in the context of a flash brewer of the present invention refers to a component or element thereof that can be carried by a person and that can be temporarily (e.g., for the duration of practicing a method) attached to a room, a space, or a defined environment.

As used herein, the term “thermally connected” refers to two liquids, each passing through a separate flow path, that are capable of heat exchange, wherein when the two flow paths are positioned in sufficiently close proximity the colder liquid flowing in a first flow path cools down the hotter liquid flowing in a second flow path and wherein the hotter liquid flowing in the second flow path heats up the colder liquid flowing in the first flow path.

In the following description it is to understood that terms such as “forward,” “rearward,” “front,” “back,” “right,” “left,” upward,” “downward,” “horizontal,” “vertical,” “longitudinal,” “lateral,” “angular,” “first,” “second,” “third,” forth,” fifth,” sixth,” seventh, eighth,” ninth,” “tenth” and the like are words of convenience and are not to be construed as limiting terms.

A need has arisen to provide devices, systems and methods to cold brew coffee. More specifically, a need has arisen to provide devices, systems and methods to brew coffee beginning with a hot brewed coffee and passing the hot brewed coffee through devices and systems of the present invention and using methods described herein that would cool the coffee form about 200 degrees F. to about 33 degrees F. One of the advantageous of cold brewing in accordance with some embodiments is the speed at which cold brewing is accomplished, thereby preserving volatile aromatics in liquid form. For example, the freshly brewed coffee may be chilled through a single pass through the liquid flow assembly. As added benefits devices, systems and methods of the embodiments keep the coffee (or another liquid, such as tea) out of the “bacterial zone” temperature range. Further, devices, systems and methods of the embodiments protect the coffee from detrimental aspects of oxidization. Further protection from oxidization is achieved with the addition of an argon and or nitrogen flush to the brew cycle. It should be stated that some methods of the present invention are applicable directly to the brewing of batches as opposed to single cups at a time brewing.

The embodiments describe a variety of systems for a flash brewer, an apparatus useful for cold brewing of coffee. The systems for a flash brewer described herein can also be used for cold brewing tea. As such, without further reiterating this understanding, when specific embodiments refer to “coffee,” they also are amenable for “tea.” Furthermore, the embodiments, as described herein, may be used to chill other beverages and as such the description of the embodiments with respect to coffee and tea is for illustration purposes only and should not limit the scope of the embodiments.

In some embodiments the system of a flash brewer comprises one or more of the following components: (i) an insulated container comprising a cooling flow assembly and a coffee flow assembly, (ii) a means for introducing coffee into the coffee flow assembly, (iii) a collection container, (iv) a coolant delivery device, (v) a circulation pump, (vi) a vacuum pump, (vii) a support stand, and (viii) means for operatively connecting components (i), (ii), (iii), (iv), (v), (vi), and (vii) to components of the system.

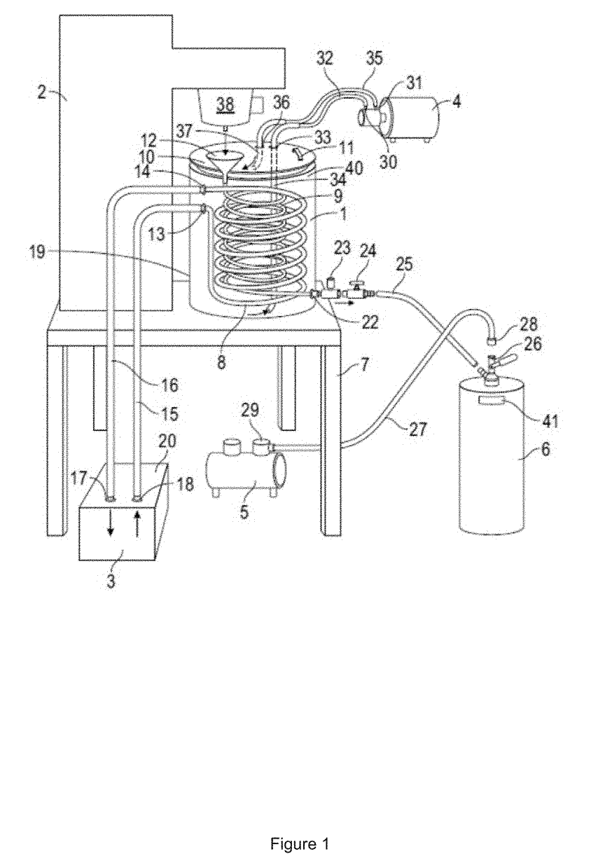

Referring now to FIG. 1 a flash brewer in accordance with some embodiments is shown. In this exemplary embodiment, a flash brewer system comprises an insulated container 1, a hot coffee brewer 2, a glycol chiller 3, a circulation pump 4, a vacuum pump 5, a collection container 6, and a support platform 7. In the interior part of the insulated container 1 is a cooling flow assembly 8 and a coffee flow assembly 9. In the exemplary embodiment depicted, the cooling flow assembly 8 is schematically depicted as a cooling flow coil assembly and the coffee flow assembly 9 is schematically depicted as a coffee flow coil assembly. In some embodiments, the cooling flow assembly 8 is connected thermally, but not in a fluid-conducting manner with a coffee flow assembly 9. It is appreciated that the flash brewer as described herein may be assembled on a support stand 7 comprises a plurality of legs. The legs can be of various height. In some embodiments, the support stand 7 comprises a plurality of wheels.

In the exemplary embodiment depicted, the insulated container 1 comprises a lid 10 with an opening, referred to herein also as a coffee flow assembly inlet 21, through which a funnel 12 can be inserted. The lid 10 comprises an upper surface and a lower surface. In the embodiment depicted in FIG. 1, the lid 10 further comprises a handle 11 attached to its upper surface.

In the embodiment schematically depicted in FIG. 1, the insulated container 1 comprises a coolant inlet 13, a coolant outlet 14, a coffee inlet 21, and a coffee outlet 22, each one comprising a first end and a second end.

In the embodiment schematically depicted in FIG. 1, the coolant inlet 13 is attached to a wall 19 of the insulated container 1 so that the first end of the coolant inlet 13 protrudes outside of the wall 19 of the insulated container 1 and the second end of the coolant inlet 13 protrudes towards the inside of the wall 19 of the insulated container 1. The coolant outlet 14 is attached to the wall 19 of the insulated container 1 so that the first end of the coolant outlet 14 protrudes outside of the wall 19 of the insulated container 1 and the second end of the coolant outlet 14 protrudes towards the inside of the wall 19 of the insulated container 1.

In the exemplary embodiment shown in FIG. 1, the coffee inlet 21 is attached to the first end of the coffee flow coil assembly 9 so that the first end of the coffee inlet 21 protrudes outside of the insulated container 1 and the second end of the coffee inlet 21 is operatively connected to the first end of the coffee flow coil assembly 9. The coffee outlet 22 is attached to the wall 19 of the insulated container 1 so that the first end of the coffee outlet 22 protrudes outside of the wall 19 of the insulated container 1 and the second end of the coffee outlet 22 protrudes towards the inside of the wall 19 of the insulated container 1. The second end of the coffee outlet 22 protruding towards the inside of the wall 19 of the insulated container 1 is operatively connected to the second end of the coffee flow coil assembly 9.

The coolant inlet 13 is configured to adapt a first tubing 15, which operatively connects the insulated container 1 to a coolant delivery device 3, here a glycol chiller 3. The coolant outlet 14 is configured to adapt a second tubing 16, which operatively connects the insulated container 1 to the glycol chiller 3.

In the embodiment schematically depicted in FIG. 1, the glycol chiller 3 comprises a glycol chiller outlet 17 and a glycol chiller inlet 18, each one comprising a first end and a second end.

The glycol chiller outlet 17 is operatively attached to a wall 20 of the glycol chiller 3 so that the first end of the glycol chiller outlet 17 protrudes outside of the wall 20 of the glycol chiller 3 and the second end of the glycol chiller outlet 17 protrudes towards the inside of the wall 20 of the glycol chiller 3. The glycol chiller inlet 18 is operatively attached to the wall 20 of the glycol chiller 3 so that the first end of the glycol chiller inlet 18 protrudes outside of the wall 20 of the glycol chiller 3 and the second end of the glycol chiller inlet 18 protrudes towards the inside of the wall 20 of the glycol chiller 3.

In the embodiment schematically depicted in FIG. 1, the first tubing 15 is configured to operatively connect the insulated container 1 with the glycol chiller 3. The first tubing 15 is operatively attached to the insulated coolant inlet 13, more specifically to the first end of the coolant inlet 13 protruding outside of the wall 19 of the insulated container 1. The first tubing 15 is also operatively attached to the glycol chiller outlet 17, more specifically to the first end of the glycol chiller outlet 17 protruding outside of the wall 20 of the glycol chiller 3.

In the embodiment schematically depicted in FIG. 1, the second tubing 16 is configured to operatively connect the insulated container 1 with the glycol chiller 3. The second tubing 16 is operatively attached to the coolant outlet 14, more specifically to the first end of the coolant outlet 14 protruding outside of the wall 19 of the insulated container 1. The second tubing 16 is also operatively attached to the glycol chiller inlet 18, more specifically to the first end of the glycol chiller inlet 18 protruding outside of the wall 20 of the glycol chiller 3.

The interior of the insulated container 1 comprises a cooling flow assembly 8. In the exemplary embodiment schematically depicted in FIG. 1, the cooling flow assembly 8 is depicted as a cooling flow coil assembly. The cooling flow coil assembly 8 comprises a first end, a second end, and an interior part. The first end of the cooling flow assembly 8 is operatively connected to coolant inlet 13, more specifically to the second end of the coolant inlet 13 protruding towards the inside of the wall 19 of the insulated container 1. The second end of the cooling flow coil assembly 8 is operatively connected to the coolant outlet 14, more specifically to the second end of the coolant outlet 14 protruding towards the inside of the wall 19 of the insulated container 1. The interior part of the cooling flow assembly 8 is hollow and permits flowing of a liquid coolant inside.

The interior of the insulated container 1 comprises a coffee flow assembly 9. In the exemplary embodiment schematically depicted in FIG. 1, the coffee flow assembly 9 is depicted as a coffee flow coil assembly. The coffee flow coil assembly 9 comprises a first end, a second end, and an interior part. The first end of the coffee flow coil assembly 9 is operatively connected to the coffee inlet 21, into which, as schematically depicted in FIG. 1, a funnel 12 can be inserted. The second end of the coffee flow assembly 9 is connected to the coffee outlet 22, more specifically to the second end of the coffee outlet 22 protruding towards the inside of the wall 19 of the insulated container 1. The interior part of the coffee flow assembly 9 is hollow and permits flowing of coffee inside.

In the embodiment schematically depicted in FIG. 1, a needle valve 23 is operatively attached to the coffee outlet 22, more specifically, to the first end of the coffee outlet 22 protruding outside of the wall 19 of the insulated container 1. The needle valve 23 comprises a first end and a second end. The first end of the needle valve 23 is operatively connected to the first end of the coffee outlet 22 protruding outside of the wall 19 of the insulated container 1. The second end of the needle valve 23 is operatively connected to the first end of a ball valve 24. The ball valve 24 comprises a first end and a second end. The first end of the ball valve 24 is operatively connected to the second end of the needle valve 23. The second end of the ball valve 24 is operatively connected to the first end of a third tubing 25. A second end of the third tubing 25 is operatively connected to a lower protrusion of dual port tank coupler 26. The dual port tank coupler 26 is operatively attached to a collection container 6. The dual port tank coupler 26 is operatively connected to a vacuum pump 5 through a fourth tubing 27. The fourth tubing 27 operatively connects to an upper protrusion of the dual port tank coupler 26 through gas port 28 and to the vacuum pump 5 through vacuum pump port 29.

In the exemplary embodiment schematically depicted in FIG. 1, a system for a flash brewer further comprises a circulation pump 4. The circulation pump 4 circulates a liquid 40 in the interior of the insulated container 1. It is appreciated that the liquid 40 may maintain a desired temperature within the insulated container 1. The liquid 40 may be water, saltwater solution, a liquid solution comprising a glycol compound, etc. As schematically depicted in FIG. 1, the circulation pump 4 comprises a circulation pump inlet 30 and a circulation pump outlet 31. A fifth tubing 32 is operatively connected to the circulation pump inlet 30. The fifth tubing 32 is also operatively connected to a first tubing inlet 33 within lid 10. Operatively attached to the first tubing inlet 33 is a sixth tubing 34. The first end of the sixth tubing 34 is operatively attached to the first tubing inlet 33 and the second end of the sixth tubing 34 is open. A seventh tubing 35 is operatively connected to the circulation pump outlet 31. The seventh tubing 35 is also operatively connected to a second tubing inlet 36 within lid 10. An eighth tubing 37 is operatively attached to the second tubing inlet 36. The first end of the eighth tubing 37 is operatively attached to the second tubing inlet 36 and the second end of the eighth tubing 37 is open.

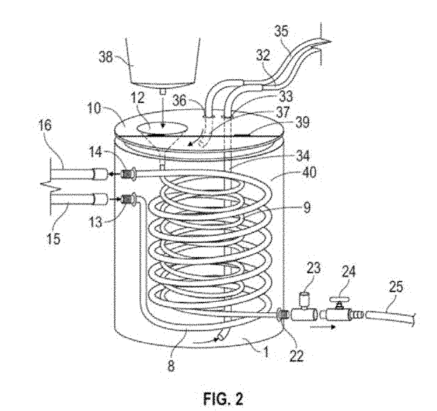

Arrows schematically depict flow directions of coffee passing from or dripping from a brew basket 38 of the hot coffee brewer 2 into funnel 12 and flowing through the interior part of the coffee flow coil assembly 9 and leaving the coffee flow coil assembly 9 and the insulated container 1 through the coffee outlet 22 and through the third tubing 23 into collection container 6. A collection container may comprise one or more handles 41. Arrows in FIGS. 1 and 2 schematically depict flow directions of coffee passing from or dripping from a brew basket 38 of the hot coffee brewer 2 into a funnel 12 and flowing through the interior part of the coffee flow coil assembly 9 and leaving the coffee flow coil assembly 9 and the insulated container 1 through the coffee outlet 22 and through the third tubing 23 into collection container 6. It is appreciated that the funnel 12 may be a removable funnel or it may be operatively connected to the coffee flow assembly 9. In some embodiments, the funnel 12 may be operatively attached to the lid 10 of the insulated container 1.

It is appreciated that the liquid 40 temperature, e.g., water temperature, is substantially determined by the coolant circulating through the cooling flow assembly 8 and to another extent by the coffee passing through the coffee flow assembly 9. In some embodiments, a temperature of the liquid 40 is selected from the group consisting of a liquid having a temperature in the range of from about 8° C. to about 10° C., a liquid having a temperature in the range of from about 6° C. to about 8° C., a liquid having a temperature in the range of from about 4° C. to about 6° C., a liquid having a temperature in the range of from about 2° C. to about 4° C., and a liquid having a temperature in the range of from about 0.1° C. to about 2° C. In some embodiments, a desired temperature of the liquid 40 may be less than about 8° C., less than about 7° C., less than about 6° C., less than about 5° C., less than 4° C., less than 2° C., less than about 0.1° C. In some embodiments of the present invention, a desired temperature of the liquid is no more than about 10° C., no more than about 8° C., no more than about 6° C., no more than about 4° C., and no more than about 2° C.

In some embodiments of the present invention, an insulated container 1 comprises a liquid temperature sensor for detecting a liquid temperature. In some embodiments of the present invention, the liquid 40 residing in the insulated container 1 is circulated within the insulated container 1. Circulation of liquid 40 in the insulated container 1 provides a liquid 40 having a substantially homogenous temperature. Circulation of liquid 40 in the insulated container 1 is achieved by using a circulation pump 4 and tubings operatively connected thereto as described herein. The circulation pump 4 is configured to circulate a liquid 40 in the interior of the insulated container 1 so that liquid 40 has substantially a homogenous desired temperature.

In some embodiments, a circulation pump 4 comprises a circulation pump inlet 30 and a circulation pump outlet 31. (schematically depicted in FIG. 1.) as described further herein, tubings may be connected to the circulation pump inlet 30 and to the circulation pump outlet 31.

In some embodiments the tubings connected to the circulation pump 4 comprise a fifth tubing 32, a sixth tubing 34, a seventh tubing 35, and an eighth tubing 37, liquid 40 enters through the open end of the sixth tubing 34. It then passes through the sixth tubing 34 into the fifth tubing 32 and from there through the circulation pump inlet 30 into the circulation pump 4. The liquid 40 then leaves the circulation pump 4 through circulation pump outlet 31 into seventh tubing 35. It then passes through the seventh tubing 35 into the eighth tubing 37 and exits it at the open end of the eighth tubing 37 into the interior of the insulated container 1. (schematically depicted in FIG. 2.) In this embodiment, the open end of the eighth tubing 37 is positioned in the upper part, closer to the top, of the insulated container 1 and open end of the sixth tubing 34 is positioned in the lower part, closer to the bottom, of insulated container 1.

In some embodiments the tubings connected to the circulation pump 4 comprise a fifth tubing 32, a sixth tubing 34, a seventh tubing 35, and an eighth tubing 37, liquid 40 enters through the open end of the sixth tubing 34. It then passes through the sixth tubing 34 into the fifth tubing 32 and from there through the circulation pump inlet 30 into the circulation pump 4. The liquid 40 then leaves the circulation pump 4 through circulation pump outlet 31 into seventh tubing 35. It then passes through the seventh tubing 35 into the eighth tubing 37 and exits it at the open end of the eighth tubing 37 into the interior of the insulated container 1. (schematically depicted in FIG. 2.)

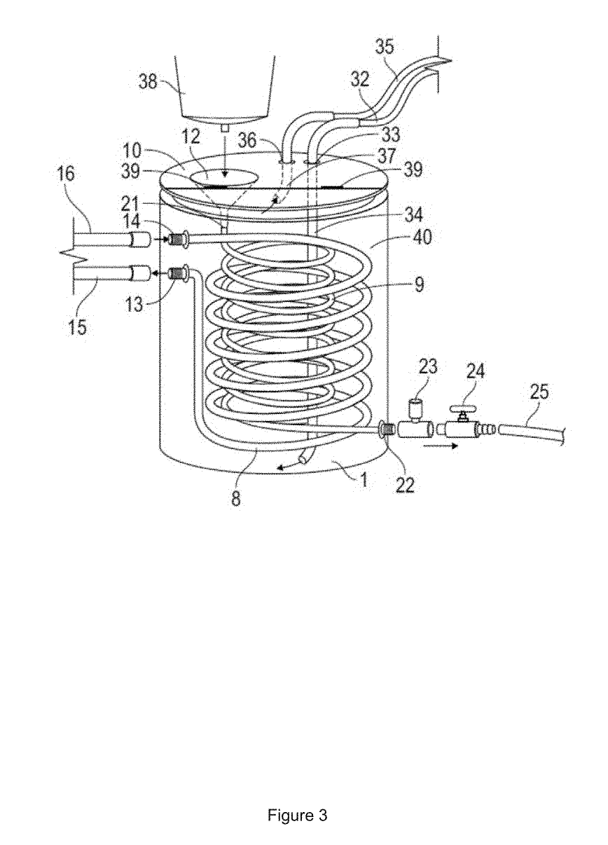

It is appreciated that the flow direction of the liquid 40 can also be reversed such that the liquid 40 enters the circulation pump 4 through the eighth tubing 37 and seventh tubing 35 and leaves the circulation pump 4 through the fifth tubing 32 and sixth tubing 34, as schematically depicted in FIG. 3.

In some embodiments, the liquid 40 residing in the insulated container 1 is stirred within the insulated container 1, thereby achieving a uniform and homogenous temperature. Stirring of liquid 40 in the insulated container 1 provides a liquid 40 having substantially homogenous temperature. Stirring of liquid 40 in the insulated container 1 is achieved by using a stirrer operatively attached to an interior part of the insulated container 1.

In some embodiments, a plurality of stirrers is attached to the interior of an insulated container 1. In some embodiments, a plurality of stirrers comprises at least two stirrers, at least three stirrers, at least four stirrers, at least five stirrers. When more than one stirrer, the stirrers are operatively connected to an interior of the insulated container at different positions. In some embodiments, a stirrer or a plurality of stirrers is attached to either an interior wall of the insulated container 1, to the interior bottom of the insulated container 1, or to the lower surface of a lid 10, which then is positioned onto the insulated container 1. A stirrer may be driven by a motor. The motor may be variable in speed to drive the agitator mechanism at different rates (e.g., operate the agitator at different rates of operation). In some embodiments, the motor speed may vary between a set of discrete speeds or may vary continuously.

In some embodiments, the liquid 40 residing in the insulated container 1 is agitated within the insulated container 1. Agitating of liquid 40 in the insulated container 1 provides a liquid 40 having substantially homogenous temperature. Agitation of liquid 40 in the insulated container 1 is achieved by using an agitator mechanism. According to some embodiments, the agitator mechanism is driven by a motor. The motor may be variable in speed to drive the agitator mechanism at different rates (e.g., operate the agitator at different rates of operation). In some embodiments, the motor speed may vary between a set of discrete speeds or may vary continuously.

In some embodiments, an agitator mechanism comprises a rotating impeller arranged to provide a flow of liquid 40 within the insulated container 1. In other embodiments, the agitator mechanism may be any other mechanism suitable to cause movement of the liquid 40 within the insulated container 1.

It is appreciated that the insulated container 1 may be of any size, shape, height, and diameter and can be used in the systems and methods of the present invention as long as they have at least one opening through which a liquid can be introduced or collected from. Thus, typically, an insulated container 1 is a closed container with one or more openings at the top and/or one or more inlets or outlets at a wall of the insulated container 1 for operatively connecting to other components of a system of a flash brewer as further described herein.

The volume of an insulated container 1 may vary. It is appreciated that the volume of an insulated container 1 may be selected depending on the volume (e.g., selected from the group consisting of at least about 0.1 gallon, at least about 0.2 gallon, at least about 0.3 gallon, at least about 0.5 gallon, at least about 1 gallon, at least about 3 gallons, at least about 5 gallons, at least about 7 gallons, at least about 10 gallons, at least about 15 gallons, at least about 20 gallons, at least about 25 gallons, at least about 30 gallons, at least about 35 gallons, at least about 40 gallons, at least about 45 gallons, at least about 50 gallons, at least about 60 gallons, at least about 70 gallons, at least about 80 gallons, at least about 90 gallons, at least about 100 gallons, at least about 150 gallons, at least about 200 gallons, at least about 250 gallons, at least about 300 gallons, at least about 400 gallons, and at least about 500 gallons) of coffee desired to be cold brewed. In some embodiments, the volume of an insulated container ranges from about 0.1 gallon to about 500 gallons. In some embodiments of the present invention, the volume of an insulated container ranges from about 0.2 gallon to about 400 gallons. In some embodiments the volume of an insulated container ranges from about 0.3 gallon to about 300 gallons. In some embodiments, the volume of an insulated container ranges from about 1 gallon to about 200 gallons. In some embodiments, the volume of an insulated container ranges from about 3 gallons to about 150 gallons. In some embodiments, the volume of an insulated container ranges from about 100 gallons. In some embodiments, the volume of an insulated container ranges from about 7 gallons to about 90 gallons. In some embodiments, the volume of an insulated container ranges from about 10 gallons to about 80 gallons. In some embodiments, the volume of an insulated container ranges from about 15 gallons to about 70 gallons. In some embodiments, the volume of an insulated container ranges from about 20 gallons to about 60 gallons. In some embodiments, the volume of an insulated container ranges from about 25 gallons to about 50 gallons. In some embodiments, the volume of an insulated container ranges from about 30 gallons to about 45 gallons. In some embodiments, the volume of an insulated container ranges from about 35 gallons to about 40 gallons.

The dimensions of an insulated container 1 may also vary. The dimensions of an insulated container 1 may be selected depending on the volume of coffee desired to be cold brewed. In some embodiments, the circumference of an insulated container ranges from about 10 inches to about 1,000 inches, from about 20 inches to about 750 inches, from about 30 inches to about 500 inches, from about 50 to about 400 inches, from about 60 inches to about 300 inches, from about 70 inches to about 200 inches, etc. In some embodiments the height of an insulated container ranges from about 10 inches to about 200 inches, from about 15 inches to about 150 inches, from about 20 inches to about 120 inches, from about 30 to about 100 inches, from about 40 inches to about 80 inches, from about 50 inches to about 70 inches.

An insulated container 1 may comprise an inner wall and an outer wall. The inner and outer walls of the insulated container 1 may be made of various materials. Non-limiting materials for the inner and outer wall of an insulated container 1 include stainless steel, tri-plated steel, nickel, aluminum, porcelain, glass jacket, and glass coatings. In some embodiments, the materials for the inner wall and outer wall of an insulated container are different from each other. In some embodiments, the materials for the inner wall and outer wall of an insulated container 1 are the same. The insulated container 1 may include insulation material. In some embodiments, insulation materials include, but are not limited to, e.g., glass fiber, ceramic fiber and a vacuum.

The form and shape of an insulated container 1 may also vary. Non-limiting forms and shapes for an insulated container include round, oval, square, rectangular, octagonal, etc.

In some embodiments, the insulated container 1 comprises a lid “10.” The lid 10 comprises an outer surface and an inner surface. The inner surface is directed towards the interior of the insulated container 1 and the outer surface towards the opposite direction. All lids described herein can be configured to comprise one or more attachments as described herein and/or can be configured to comprise one or more inlets or outlets through which a funnel or parts thereof or other components may be inserted inwardly into the insulated container or outwardly from the insulated container. When a lid is present and when practicing a method as described herein, the lid may be closed. It is appreciated that the lid 10 may be removable, permanently attached, e.g., via fasteners, screws, etc., to the insulated container 1, partially attached e.g., via fasteners, screws, etc., to the insulated container 1, etc. In some embodiments, the lid 10 comprises one or more handles (indicated by 11 in the figures). The one or more handles 11 are operatively attached to the outer surface of the lid so that a user can grip the one or more handles and move the lid. In some embodiments, the insulated container 1 comprises a lid 10 with a hinge (indicated by 39 in the figures). In embodiments wherein the lid 10 comprises a single hinge 39, the hinge 39 can extend substantially across the diameter of the lid 10. In some embodiments, the insulated container comprises a lid 10 with a plurality of hinges (indicated by 39 in the figures). In some embodiments a plurality of hinges 39 comprises at least two hinges 39, at least three hinges 39, at least four hinges 39, at least five hinges 39. In some embodiments, the lid 10 may have additional attachments. For example, the lid 10 may include an integrated funnel. In such embodiment, the funnel may be permanently attached to the lid 10. In some embodiments, the lid 10 comprises an opening, referred to herein also as a coffee inlet 21, through which a funnel 12 can be inserted.

In some embodiments, a cooling flow assembly is a cooling flow coil assembly 8. A cooling flow coil assembly is a preferred cooling flow assembly when the coolant is a liquid, such as glycol or liquid nitrogen. In some embodiments, the cooling flow coil assembly 8 is configured to permit a liquid coolant to flow and pass through the interior of it. Thus, a cooling flow coil assembly 8 comprises a first end, an second end and an interior hollow part.

The diameter of a cooling flow coil assembly 8 may be selected to achieve a desired cooling effect. For example, a diameter for a cooling flow coil assembly may be selected from group consisting of a range from about 0.25″ to 0.375″, from about 0.375″ to about 0.5″, from about 0.5″ to about 0.625″, from about 0.625″ to about 0.75″, from about 0.75″ to about 0.875″, and from about 0.875″ to about 1″. In some embodiments, the diameters for a cooling flow coil assembly 8 is at least about 0.125″, at least about 0.25″, at least about 0.375″, at least about 0.5″, at least about 0.625″, at least about 0.75″, at least about 0.875″, or at least about 1″. In some embodiments, the diameters for a cooling flow coil assembly 8 is less than about 1″, less than about 0.875″, less than about 0.75″, less than about 0.625″, less than about 0.5″, less than about 0.375″, less than about 0.25″, or less than 0.125″. It is appreciated that the cooling flow coil assembly 8 may have various diameters. The diameter of the cooling flow coil assembly 8 substantially is determined by the diameter of the insulated container. The diameter of the cooling flow coil assembly 8 is smaller than the diameter of the insulated container 1.

It is appreciated that the cooling flow coil assembly 8 may have various shapes and forms. The shape and form of a cooling flow coil assembly 8 may be selected to permit the coolant to flow through the cooling flow coil assembly 8. For example, in some embodiments, a cooling flow coil assembly 8 is substantially round. In some embodiments, a cooling flow coil assembly 8 is substantially oval. In some embodiments, a cooling flow coil assembly 8 is substantially rectangular. In some embodiments, a cooling flow coil assembly 8 is substantially square. In some embodiments, a cooling flow coil assembly 8 comprises more than a single shape or form and comprises round, oval square and/or rectangular hollow parts through which a coolant can flow.

The cooling flow coil assembly 8 comprises a first end, a second end, and an interior part. The first end of the cooling flow coil assembly 8 is operatively connected to an inlet positioned at a wall 19 of the insulated container 1. This inlet is referred to herein as coolant inlet 13. The first end of the cooling flow assembly 8 is operatively connected to coolant inlet 13, more specifically to the second end of the coolant inlet 13 protruding towards the inside of the wall 19 of the insulated container 1. As is described further herein, a coolant enters the first end of the cooling flow coil assembly 8 by passing through the coolant inlet 13. This is schematically depicted, e.g., in FIG. 2. Once the coolant has entered the interior hollow part of the cooling flow coil assembly 8, it moves through that interior part towards the second end of the cooling flow coil assembly 8.

The second end of the cooling flow coil assembly is operatively connected to an outlet positioned at a wall 19 of the insulated container 1. This outlet is referred to herein as coolant outlet 14. More specifically, the second end of the cooling flow coil assembly 8 is operatively connected to second end of the coolant outlet 14 protruding towards the inside of the wall 19 of the insulated container 1. As is described further herein, a coolant, after passing through the interior hollow part of the cooling flow coil assembly 8 leaves the cooling flow coil assembly 8 by passing through the coolant outlet 14. This is schematically depicted, e.g., in FIG. 2.

The material for the cooling flow coil assembly can vary. In some embodiments of the present invention, the material for a cooling flow coil assembly is copper, stainless steel, aluminum, tri-ply, or a finned tubing.

In some embodiments, the insulated container 1 comprises an inlet 13 for a coolant, referred to herein as coolant inlet, and an outlet 14 for a coolant, referred to herein as coolant outlet, each having a first end and a second end. In some figures, an exemplary coolant inlet is schematically depicted by “13” and an exemplary coolant outlet is schematically depicted by “14.” In FIG. 3, an exemplary coolant inlet is schematically depicted by “14” and an exemplary coolant outlet is schematically depicted by “13.”

In some embodiments, the coolant inlet 13 is attached to a wall 19 of the insulated container 1 so that the first end of the coolant inlet 13 protrudes outside of the wall 19 of the insulated container 1 and the second end of the coolant inlet 13 protrudes towards the inside of the wall 19 of the insulated container 1. (FIGS. 1 and 2.). In some embodiments, the coolant inlet 13 is configured to adapt a first tubing 15, which operatively connects the insulated container 1 to a coolant delivery device 3 as further described herein.

In some embodiments, the coolant outlet 14 is attached to a wall 19 of the insulated container 1 so that the first end of the coolant outlet 14 protrudes outside of the wall 19 of the insulated container 1 and the second end of the coolant outlet 14 protrudes towards the inside of the wall 19 of the insulated container 1. (e.g., see, FIGS. 1 and 2.). In some embodiments, the coolant outlet 14 is configured to adapt a second tubing 16, which operatively connects the insulated container 1 to the coolant delivery device 3, as further described herein.

In some embodiments, and as schematically depicted in FIGS. 1 and 2, a coolant passing through first tubing 15 enters the cooling flow assembly 8 through coolant inlet 13 and then flows upwards through the cooling flow assembly 8 until it leaves the cooling flow assembly 8 through the coolant outlet 14 into second tubing 16 through which it flows back into the coolant delivery device 3. It is appreciated that the flow direction of the coolant can also be reversed such that the coolant enters the cooling flow assembly 8 through coolant outlet 14, which then would be considered a ‘coolant inlet’ and leaves the cooling flow assembly 8 through coolant inlet 13, which then would be considered a ‘coolant outlet.’ In such situation, the coolant would leave the coolant delivery device 3 through second tubing 16 and returns into the coolant delivery device 3 through first tubing 15. Thus, in some embodiments, and as schematically depicted in FIG. 3, a coolant passing through second tubing 16 enters the cooling flow assembly 8 through a coolant inlet (depicted as 14 in FIG. 3) and then flows downwards through the cooling flow assembly 8 until it leaves the cooling flow assembly 8 through a coolant outlet (depicted as 13 in FIG. 3) into the first tubing 15 through which it flows back into the coolant delivery device 3. In some embodiments, the coolant delivery device 3 is operatively and functionally connected to or attached to the insulated container 1.

In some embodiments, the coolant delivery device 3 comprises a coolant pump. In some embodiments, the coolant delivery device 3 comprises an electric coolant pump. In some embodiments, the coolant delivery device 3 comprises an electrically-actuated pump. The electric coolant pump or electrically-actuated pump may be driven by a motor. The motor may be varied in speed to provide variable pumping rates of the coolant through the cooling flow assembly 8. In some embodiments, the coolant pump 3 comprises a reservoir configured to hold a coolant. In some embodiments, the coolant pump delivers or circulates a liquid coolant through one or more coolant lines. In some embodiments, the coolant pump delivers or circulates a liquid coolant through a cooling flow assembly 8, e.g., through a cooling flow coil assembly, as described herein. It is appreciated that the coolant delivery device 3 may include a coolant temperature sensor for detecting a coolant temperature. The coolant pump can be operated for a preset period of time following a starting of cold brewing coffee process.

The coolant delivery device 3 may be equipped in terms of hardware and/or software for carrying out a method described herein. For example, a pump controller can be configured to operate the coolant pump for a preset period of time after a starting of the cold brewing coffee process. In some embodiments, the coolant pump is shut down following the expiration of the preset period of time. Upon sensing that the liquid temperature is falling below a desired threshold level, the coolant pump may be switched on again and deliver coolant to the insulated container 1 to reduce the liquid temperature to a desired temperature.

Various coolants may be used. Non-limiting examples of coolants include an ethylene glycol compound, dry ice, and liquid nitrogen. The coolant may be chosen so as to have good thermal conductivity and low viscosity. Glycols have long been used in coolant compositions as the primary coolant and freezing point depressant component. Depending on the temperature range of the internal environment in which a system is to be operated, varying amounts of water may typically be added to extend the coolant composition. As a result the user is able to dilute the coolant composition as needed to obtain the desired low and high temperature protection under the expected duty conditions. It should be noted, though, that protection against corrosion of the internal parts of the coolant delivery device may be required over the entire range of dilution of the coolant composition.

In some embodiments, a coolant is a glycol compound selected from the group consisting of ethylene glycol, diethylene glycol, triethylene glycol, propylene glycol, and combinations thereof. As used herein, a simple reference to a glycol compound means ethylene glycol, diethylene glycol, triethylene glycol, propylene glycol or combinations thereof. Additionally, glycol ethers may be used as the coolant liquid alone or in combination with the above glycols. The glycol ethers include, but are not limited to, the methyl, ethyl, propyl, and butyl ethers of ethylene glycol, and mixtures thereof. Glycerin may also be used as a coolant liquid. In some embodiments, a coolant utilizes at least 50% by weight of a glycol or glycol ether components. In some embodiments, a coolant utilizes from 55% to 95% by weight of one or more of the above glycol or glycol ether components. In some embodiments, a coolant utilizes from 70% to 95% by weight of one or more of the glycol or glycol ether components. In some embodiments, a coolant utilizes from 85% to 95% by weight of one or more of the glycol or glycol ether components. In some embodiments, a coolant utilizes from 95% to 99% by weight of one or more of the glycol or glycol ether components.

In some embodiments, a coolant composition comprises one or more buffer materials. The one or more buffer materials may be selected from the group consisting of 2-hydroxybenzoic acid, 3-hydroxybenzoic acid, 4-hydroxybenzoic acid, 2,4-dihydroxybenzoic acid, 2,6-dihydroxybenzoic acid, and combinations thereof. Use of appropriate concentrations of the buffer material minimizes or even eliminates the need to introduce additional pH-adjusting compounds over the service life of a coolant composition. As a result, the service life can be extended.

In some embodiments, a coolant composition comprises a corrosion inhibitor. Corrosion inhibitors are particularly useful to be included in a coolant composition when using in iron-containing cooling systems. In some embodiments, a corrosion inhibitor may be selected from the group consisting of an aqueous solution of alkali metal, alkaline earth, ammonium hydroxide, sodium hydroxide, potassium hydroxide and combinations thereof. C₅-C₁₃ short chain dicarboxylic acids or their alkali metal, alkaline earth, or ammonium salts are also useful as corrosion inhibitor and may be added to a coolant composition. Further, other corrosion inhibitors, such as azoles, nitrates, silicates, molybdates, and phosphates, typically as their alkali metal, alkaline earth, or ammonium salt, usually the sodium or potassium salt are useful as corrosion inhibitor and may be added to a coolant composition.

In some embodiments, a coolant composition comprises an additive. Useful additives are selected from the group consisting of a dye, a bitterant, and a defoamer.

In embodiments where the coolant is a glycol compound, a coolant delivery device is also referred to herein as glycol chiller. In some embodiments, a glycol chiller is operatively and functionally connected to an insulated container 1. An exemplary glycol chiller is schematically depicted in FIG. 1 by “3.” In some embodiments, a glycol chiller 3 comprises a glycol chiller outlet 17 and a glycol chiller inlet 18, each one comprising a first end and a second end. (FIG. 1.). In some embodiments, a glycol chiller outlet 17 is operatively attached to a wall 20 of the glycol chiller 3 so that the first end of the glycol chiller outlet 17 protrudes outside of the wall 20 of the glycol chiller 3 and the second end of the glycol chiller outlet 17 protrudes towards the inside of the wall 20 of the glycol chiller 3. (FIG. 1.). The glycol chiller inlet 18 is operatively attached to the wall 20 of the glycol chiller 3 so that the first end of the glycol chiller inlet 18 protrudes outside of the wall 20 of the glycol chiller 3 and the second end of the glycol chiller inlet 18 protrudes towards the inside of the wall 20 of the glycol chiller 3.

In some embodiments of a glycol chiller, a glycol chiller unit comprises a second stage heat exchange unit. This will utilize water to help cool glycol before it goes back in to the chiller. In some embodiments, when the hot coffee brewer 2 draws water it will draw the water through the second stage of the glycol chiller. The heat will be exchanged from glycol to water utilizing the heat exchange to bring warm water into the hot coffee brewer 2.

In some embodiments, a coolant is dry ice. In such embodiments, the coolant delivery device comprises a device configured to house dry ice. It is appreciated that in some embodiments, a coolant is liquid nitrogen. In some embodiments, where the coolant is liquid nitrogen, the system comprises a coolant delivery device configured to allow passing of liquid nitrogen through it. In some embodiments, such device comprises a liquid nitrogen coil assembly, through which liquid nitrogen can pass through. In some embodiments, liquid nitrogen is directly injected in a coolant delivery device. In some embodiments, liquid nitrogen is semi-directly injected in a coolant delivery device. In some embodiments liquid nitrogen is indirectly injected in a coolant delivery device. In some embodiments where the coolant is liquid nitrogen, liquid nitrogen may precharge into a container, e.g., keg. This will help to cool the container/keg as well as release nitrogen gas into the tank helping to protect coffee from oxidation.

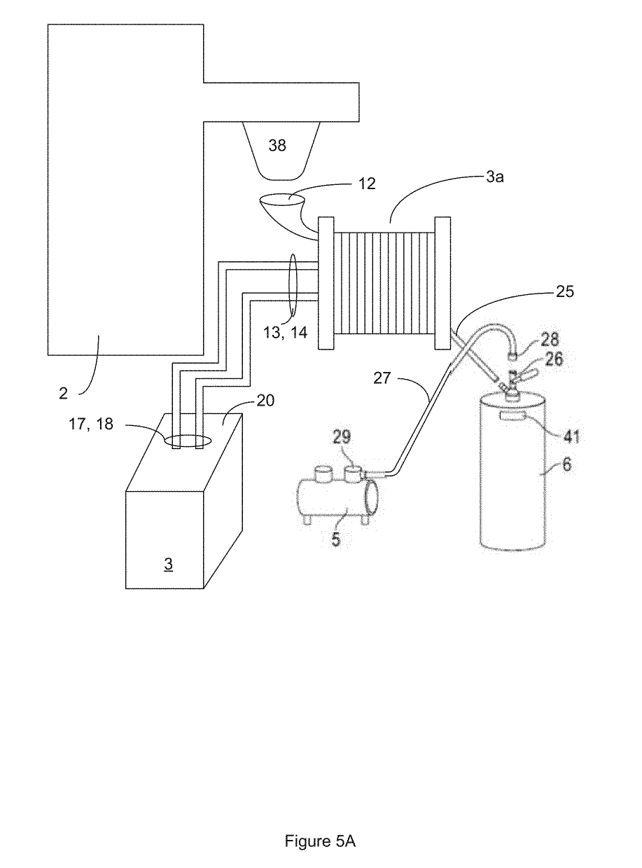

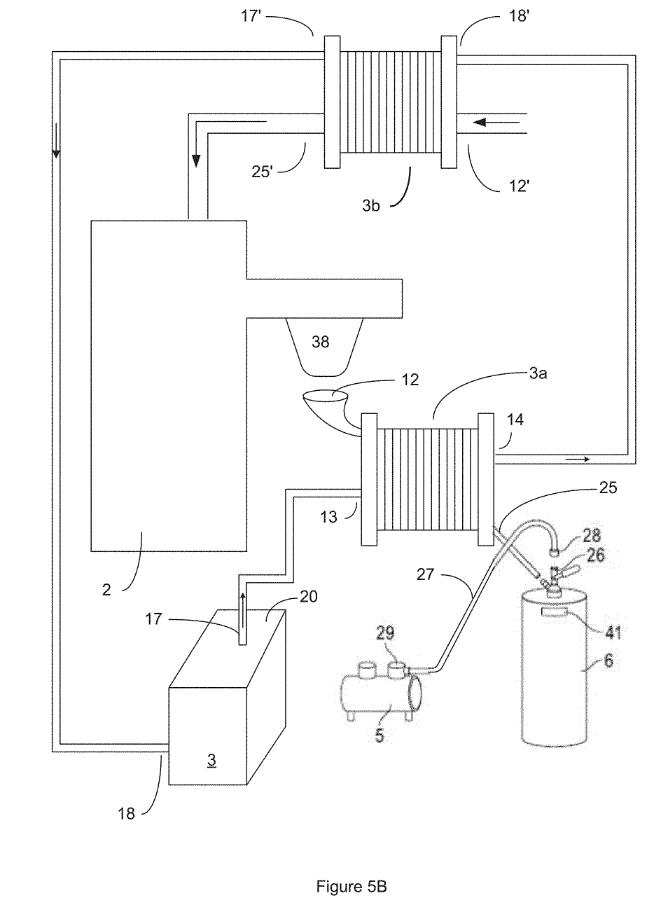

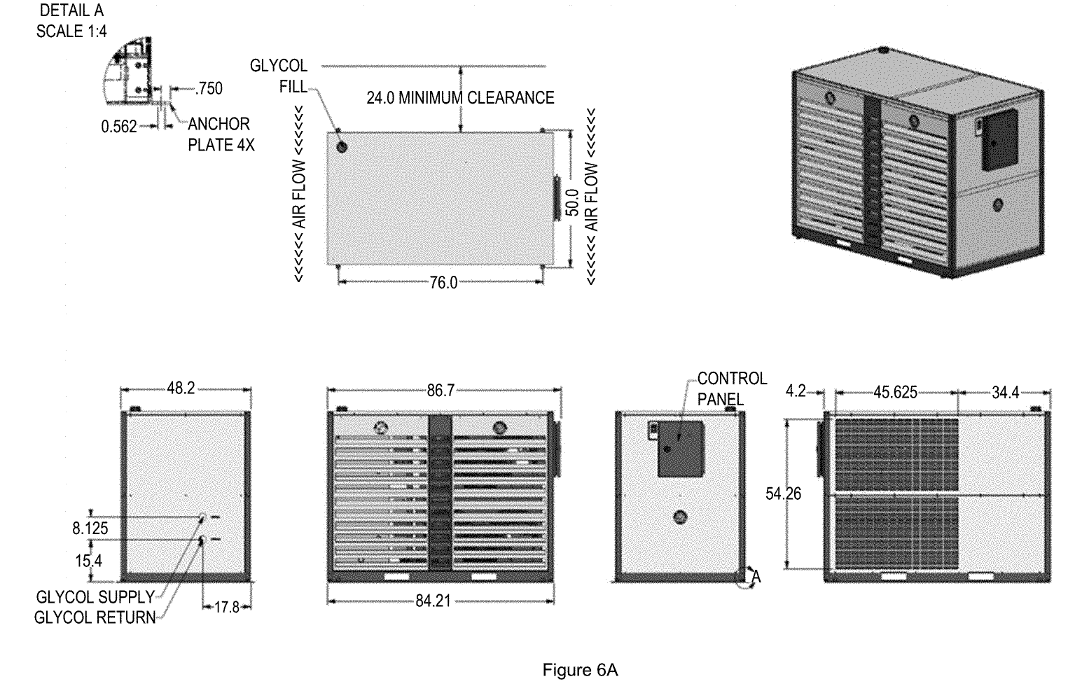

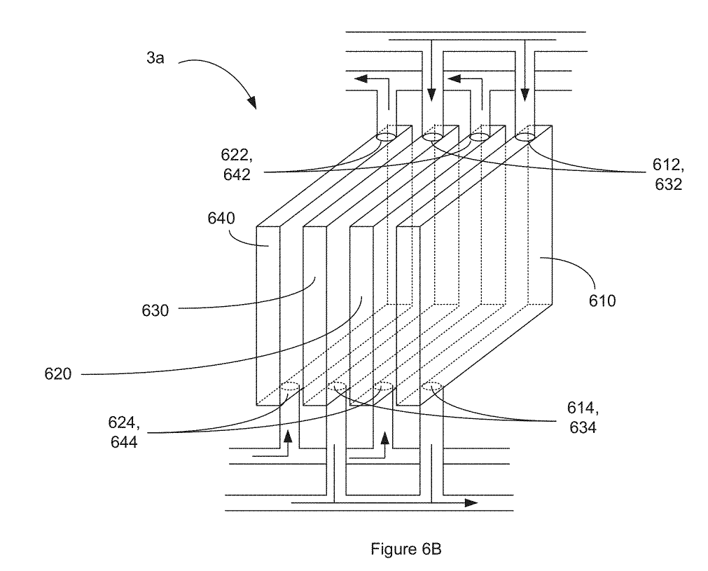

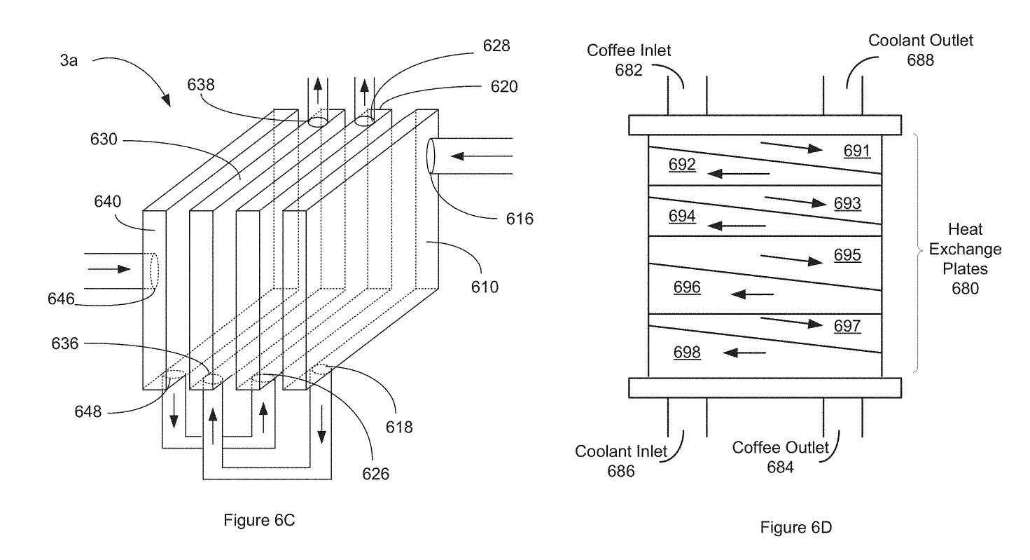

In some embodiments of the present invention, a coolant delivery device is a frame-and-plate heat exchange device. An exemplary embodiment of a system of the present invention comprising a frame-and-plate heat exchange device is schematically depicted and described in FIGS. 5A-6D.

In some embodiments, a coolant delivery device is a coil ice bath, a coil glycol bath, comprising a glycol compound as described herein, a heat transfer water reclamation, a device delivering a freon refrigerant, a device delivering a chlorofluorocarbon compound.

It is appreciated that the coffee flow assembly 9 is in geothermal contact with the cooling flow assembly 8 such that the coolant passing through the cooling flow assembly 8 decreases the temperature of the coffee passing through the coffee flow assembly 9 and the coffee passing through the coffee flow assembly increases the temperature of the coolant passing through the cooling flow assembly 8. In other words, the coolant passing through the cooling flow assembly 8 heats up by being thermally coupled to the coffee flowing through the coffee flow assembly 9. The heat exchange between the coolant in the cooling flow assembly 8 and the coffee flowing through the coffee flow assembly 9 decreases the coffee temperature, thereby chilling it.

In some embodiments, the coffee flow coil assembly 9 is configured to permit coffee to flow and pass through the interior of it. In some embodiments, the coffee flow coil assembly 9 comprises a first end, a second end, and an interior hollow part.

The diameter of a coffee flow coil assembly 9 may be selected to achieve a desired cooling of the coffee flowing through it. In some embodiments, a diameter for a coffee flow coil assembly is selected from group consisting of a range from about 0.25″ to 0.375″, from about 0.375″ to about 0.5″, from about 0.5″ to about 0.625″, from about 0.625″ to about 0.75″, from about 0.75″ to about 0.875″, and from about 0.875″ to about 1″. In some embodiments, the diameters for a coffee flow coil assembly is at least about 0.125″, at least about 0.25″, at least about 0.375″, at least about 0.5″, at least about 0.625″, at least about 0.75″, at least about 0.875″, or at least about 1″. In some embodiments, the diameter for a coffee flow coil assembly is less than about 1″, less than about 0.875″, less than about 0.75″, less than about 0.625″, less than about 0.5″, less than about 0.375″, less than about 0.25″, or less than 0.125″. As such, the diameter of a coffee flow assembly 9 can be similar or identical to the diameter of a cooling flow assembly 8. It is appreciated that the coffee flow coil assembly 9 itself can have various diameters. The diameter of the coffee flow coil assembly 9 is determined by the diameter of the insulated container 1. The diameter of the coffee flow coil assembly 8 is smaller than the diameter of the insulated container 1.

It is appreciated that the coffee flow coil assembly 9 can have various shapes and forms. The shape and form of a coffee flow coil assembly 9 is selected to permit coffee to flow through it. For example, a coffee flow coil assembly 9 may be substantially round. In some embodiments, the coffee flow coil assembly 9 may be substantially oval. In some embodiments, the coffee flow coil assembly 8 may be substantially rectangular. In some embodiments, a coffee flow coil assembly 9 may be substantially square. In some embodiments, the coffee flow coil assembly 9 may include more than a single shape or form and comprises round, oval square and/or rectangular hollow parts through which coffee can flow. As such, the shape of a coffee flow assembly 9 can be similar or identical to the shape of a cooling flow assembly 8.

In some embodiments, the first end of the coffee flow coil assembly 9 is operatively connected to the coffee inlet 21, into which a funnel 12 can be inserted. (schematically depicted, e.g., in FIG. 1.) In some embodiments of the present invention, a funnel 12 or similar conduit that permits pouring in or dripping in of coffee is operatively connected to the first end of the coffee flow coil assembly 9. In some embodiments, the second end of the coffee flow assembly 9 is operatively connected to the coffee outlet 22, more specifically to the second end of the coffee outlet 22 protruding towards the inside of the wall 19 of the insulated container 1. The interior part of the coffee flow assembly 9 is hollow and permits flowing and passing through of coffee inside.

In some embodiments, the insulated container 1 comprises an inlet 21 for coffee and an outlet 22 for coffee, each having a first end and a second end. In the figures, an exemplary coffee inlet is schematically depicted by “21” and an exemplary coffee outlet is schematically depicted by “22.”

In some embodiments, the coffee inlet 21 is attached to the first end of a coffee flow coil assembly 9 so that the first end of the coffee inlet 21 protrudes outside of the insulated container 1 and the second end of the coffee inlet 21 is operatively connected to the first end of the coffee flow coil assembly 9. In such embodiment, the coffee inlet 21 is configured to adopt a funnel 12 through which coffee can enter into the coffee flow coil assembly 9. (FIG. 1.).

In some embodiments the coffee inlet 21 is attached to a lid 10 so that the first end of the coffee inlet 21 protrudes outside of the lid 10 and the second end of the coffee inlet 21 protrudes towards the inside of the lid 10. In such embodiment the second end of the coffee inlet 21 is positioned so that it operatively connects with the first end of the coffee flow coil assembly 9. This configuration permits coffee passing through the coffee inlet 21 and entering the coffee flow coil assembly 9.

In some embodiments, a coffee inlet 21 is an integrated funnel. In such embodiment, the lower and narrower end of a funnel is operatively connected to the first end of the coffee coil assembly 9. This configuration permits filling coffee into the upper and broader end of the funnel, permitting the coffee to pass through the funnel and entering into the coffee flow coil assembly 9.

In some embodiments, the coffee outlet 22 is attached to a wall 19 of the insulated container 1 so that the first end of the coffee outlet 22 protrudes outside of the wall 19 of the insulated container 1 and the second end of the coffee outlet 22 protrudes towards the inside of the wall 19 of the insulated container 1. The second end of the coffee outlet 22 protruding towards the inside of the wall 19 of the insulated container 1 is operatively connected to the second end of the coffee flow coil assembly 9. (FIGS. 1 and 2.).

It is appreciated that in some embodiments, the collection container 6 may collect and store the chilled coffee being output from the coffee outlet 22. It is appreciated that in some embodiments, the collection container 6 is operatively and functionally connected to a coffee flow assembly 9. In some embodiments, the collection container 6 is operatively and functionally connected to the insulated container 1. In some embodiments, a collection container 6 is operatively and functionally connected to a vacuum pump 5.

Collection containers of various sizes, shapes, heights, and diameters with at least one opening through which coffee from the coffee flow assembly 9 can be introduced into or collected in. The collection container 6 may be a closed container with one or more openings at the top and/or one or more inlets or outlets at a wall of the collection container for operatively connecting to other components of a system of a flash brewer as further described herein.

The volume of a collection container 6 may vary. It is appreciated that the volume of a collection container 6 may be selected based on the volume of coffee desired to be cold brewed and the volume of coffee to be collected in the collection container. In some embodiments, the volume of collection container is selected from the group consisting of at least about 0.1 gallon, at least about 0.2 gallon, at least about 0.3 gallon, at least about 0.5 gallon, at least about 1 gallon, at least about 3 gallons, at least about 5 gallons, at least about 7 gallons, at least about 10 gallons, at least about 15 gallons, at least about 20 gallons, at least about 25 gallons, at least about 30 gallons, at least about 35 gallons, at least about 40 gallons, at least about 45 gallons, at least about 50 gallons, at least about 60 gallons, at least about 70 gallons, at least about 80 gallons, at least about 90 gallons, at least about 100 gallons, at least about 150 gallons, at least about 200 gallons, at least about 250 gallons, at least about 300 gallons, at least about 400 gallons, and at least about 500 gallons. In some embodiments, the volume of a collection container 6 ranges from about 0.1 gallon to about 500 gallons. In some embodiments, the volume of a collection container 6 ranges from about 0.2 gallon to about 400 gallons. In some embodiments, the volume of a collection container 6 ranges from about 0.3 gallon to about 300 gallons. In some embodiments, the volume of a collection container 6 ranges from about 1 gallon to about 200 gallons. In some embodiments, the volume of a collection container 6 ranges from about 3 gallons to about 150 gallons. In some embodiments, the volume of a collection container ranges 6 from about 100 gallons. In some embodiments, the volume of a collection container 6 ranges from about 7 gallons to about 90 gallons. In some embodiments, the volume of a collection container 6 ranges from about 10 gallons to about 80 gallons. In some embodiments, the volume of a collection container 6 ranges from about 15 gallons to about 70 gallons. In some embodiments, the volume of a collection container 6 ranges from about 20 gallons to about 60 gallons. In some embodiments, the volume of a collection container 6 ranges from about 25 gallons to about 50 gallons. In some embodiments, the volume of a collection container 6 ranges from about 30 gallons to about 45 gallons. In some embodiments, the volume of a collection container 6 ranges from about 35 gallons to about 40 gallons. Individual volumes for collection containers are described in the Examples. The dimensions of a collection container 6 may also vary. It is appreciated that the dimensions of the collection container 6 may be selected depending on the volume of coffee desired to be cold brewed and to collected therein. The form and shape of a collection container 6 may vary. Non-limiting forms and shapes for a collection container 6 include round, oval, square, rectangular, octagonal, and the like.

In some embodiments, the collection container 6 is insulated. Insulation materials suitable and useful for a collection container include, but are not limited to those described herein for an insulated container 1. The collection container 6 may comprise an inner wall and an outer wall. The inner and outer walls of the collection container 6 may be made of various materials. Those materials are not limited to practice the invention. Non-limiting materials for the inner and outer wall of a collection container include stainless steel, tri-plated steel, nickel, aluminum, copper porcelain, or glass. In some embodiments, the materials for the inner wall and outer wall of collection container 6 are different from each other. In some embodiments, the materials for the inner wall and outer wall of a collection container 6 are the same. It is appreciated that a vacuum pump 5 may be operatively and functionally connected to a collection container 6.

It is appreciated that the embodiments described can facilitate chilling of liquid, e.g., coffee, within a single pass. For example, coffee may be adequately chilled in a single pass through the coffee flow assembly 9. It is appreciated that heat exchange between the coffee flowing through the coffee flow assembly 9 and the coolant flowing through the cooling flow assembly 8 chills the coffee in a single pass. It is further appreciated that using liquid 40 and/or stirrer may further facilitate chilling of coffee and to maintain a uniform and homogenous temperature within the insulated container 1.

It is appreciated that components described herein may be operatively connected to one another. While means for connecting components of the system for cold brewing coffee are referred to herein as tubing, one of ordinary skill in the art will appreciate that the term tubing in this context is not limited to tubings, but rather includes pipes, piping, tubes, ducts, conduits, and the like, as long as they have an hollow interior permitting flow-through of a liquid.

In some embodiments, an insulated container 1 is operatively connected to a coolant delivery device 3. In some embodiments, a coolant delivery device 3 is a glycol chiller 3. (FIG. 1.). In some embodiments, a means for connecting an insulated container 1 to a coolant delivery device 3 comprises a first tubing 15 and a second tubing 16. (schematically depicted in FIGS. 1 and 2.). In some embodiments, a first tubing 15 is configured to operatively connect an insulated container 1 with a glycol chiller 3. More specifically, the first tubing 15 is operatively attached to the coolant inlet 13, more specifically to the first end of the coolant inlet 13 protruding outside of the wall 19 of the insulated container 1. The first tubing 15 is also operatively attached to the glycol chiller outlet 17, more specifically, to the first end of the glycol chiller outlet 17 protruding outside of the wall 20 of the glycol chiller 3. (FIGS. 1 and 2.) The glycol chiller 3 provides the glycol through the first tubing 15 into the cooling flow assembly 8 inside the insulated container 1. (schematically depicted, e.g., in FIGS. 1 and 2.)

In some embodiments, a second tubing 16 is configured to operatively connect an insulated container 1 with a glycol chiller 3. More specifically, the second tubing 16 is operatively attached to the coolant outlet 14, more specifically, to the first end of the coolant outlet 14 protruding outside of the wall 19 of the insulated container 1. The second tubing 16 is also operatively attached to the glycol chiller inlet 18, more specifically, to the first end of the glycol chiller inlet 18 protruding outside of the wall 20 of the glycol chiller 3. (schematically depicted, e.g., in FIGS. 1 and 2.). After the glycol has passed through the cooling flow assembly 8, it leaves the cooling flow assembly and the insulated container by passing through the coolant outlet 14 through the second tubing 16 into the glycol chiller 3.

In some embodiments, the insulated container 1 is operatively connected to a collection container 6. In some embodiments a means for connecting an insulated container 1 to a collection container 6 comprises one or more of the following: a needle valve 23, a ball valve 24, a third tubing 25. (schematically depicted, e.g., in FIGS. 1 and 2.). In some embodiments, a needle valve 23 is operatively attached to the coffee outlet 22, more specifically, to the first end of the coffee outlet 22 protruding outside of the wall 19 of the insulated container 1. The needle valve 23 comprises a first end and a second end. The first end of the needle valve 23 is operatively connected to the first end of the coffee outlet 22 protruding outside of the wall 19 of the insulated container 1. The second end of the needle valve 23 is operatively connected to the first end of a ball valve 24. (schematically depicted, e.g., in FIGS. 1 and 2.). In some embodiments, a ball valve 24 is operatively connected to the needle valve 23 and operatively connected to a third tubing 25. In such embodiment, the ball valve 24 comprises a first end and a second end. The first end of the ball valve 24 is operatively connected to the second end of the needle valve 23. The second end of the ball valve 24 is operatively connected to the first end of a third tubing 25. A second end of the third tubing 25 is operatively connected to a dual port tank coupler 26. (schematically depicted in, e.g., FIGS. 1-3.). The dual port tank coupler 26 is operatively attached to a collection container 6. (schematically depicted, e.g., in FIG. 1.)

In some embodiments, the collection container 6 is operatively connected to a vacuum pump 5. In some embodiments a means for connecting a collection container 6 to a vacuum pump 5 comprises a fourth tubing 27. (schematically depicted in FIG. 1.). The dual port tank coupler 26 is operatively connected to a vacuum pump 5 through a fourth tubing 27. The fourth tubing 27 operatively connects to the dual port tank coupler 26 through a gas port 28 and to the vacuum pump 5 through a vacuum pump port 29. (schematically depicted, e.g., in FIG. 1.)

In some embodiments, the circulation pump 4 is operatively connected to an insulated container 1. In some embodiments a means for connecting a circulation pump 4 to an insulated container 1 comprises one or more of the following: a fifth tubing 32, a sixth tubing 34, a seventh tubing 35, and an eighth tubing 37. (schematically depicted in FIG. 1.). A fifth tubing 32 is operatively connected to the circulation pump inlet 30. In some embodiments, the fifth tubing 32 is also operatively connected to a first tubing inlet 33 within lid 10. Operatively attached to the first tubing inlet 33 is a sixth tubing 34. The first end of the sixth tubing 34 is operatively attached to the first tubing inlet 33 and the second end of the sixth tubing 34 is open and extends towards the interior of the insulated container 1. (schematically depicted, e.g., in FIG. 1.). A seventh tubing 35 is operatively connected to the circulation pump outlet 31. In some embodiments, the seventh tubing 35 is also operatively connected to a second tubing inlet 36 within lid 10. An eighth tubing 37 is operatively attached to the second tubing inlet 36. The first end of the eighth tubing 37 is operatively attached to the second tubing inlet 36 (may also be referred to as circulation pump outlet/inlet) and the second end of the eighth tubing 37 is open and extends into the interior of the insulated container 1. (schematically depicted, e.g., in FIG. 1.)

The open ends of the sixth tubing 34 and the eighth tubing 37 extending into the insulated container 1 are distantly apart from each other. In some embodiments the open end of the sixth tubing 34 resides in the upper part of the interior of the insulated container 1 and the open end of the eighth tubing 37 resides in the lower part of interior of the insulated container 1. (schematically depicted, e.g., in FIG. 1.).

In some embodiments, the circulation pump 4 is operatively connected to an insulated container 1. In some embodiments a means for connecting a circulation pump 4 to an insulated container 1 comprises one or more of the following: a fifth tubing 32, a sixth tubing 34, a seventh tubing 35, and an eighth tubing 37. (schematically depicted in FIG. 1.).

In some embodiments, the system may facilitate an argon flow. In some embodiments, an argon flow is operatively configured to be directed to brewing basket 38. In some embodiments, an argon flow is operatively configured to be directed to a funnel 12. In some embodiments, an argon flow is operatively configured to be directed to a coffee inlet 21. In some embodiments, the system facilitates a nitrogen flow. In some embodiments, a nitrogen flow is operatively configured to be directed to brewing basket 38. In some embodiments, a nitrogen flow is operatively configured to be directed to a funnel 12. In some embodiments, the nitrogen flow is operatively configured to be directed to a coffee inlet 21. It is appreciated that nitrogen flow and/or argon flow may prevent oxidation. In some embodiments, the system comprises a nitrogen back-flush valve that is operatively connected into a receptacle. In some embodiments the nitrogen back-flush valve is operatively connected to a coffee flow assembly.

In some embodiments, the system comprises a thermostat for determining the temperature of a coolant. In such embodiments, a thermostat controlled regulator may be positioned where in FIGS. 1-3, e.g., either the needle valve 23 or the ball valve 24 is positioned.

In some embodiments, the system comprises a timer switch for the circulating pump 4. Such timer switch may be started by activation of a brewing process within hot coffee brewer 2. Additional and/or optional elements for a system of the are listed herewith: A liquid nitrogen drip into liquid (40), which may be regulated via thermostat through sidewall (19) or lid (10). It may also be operatively connected to a liquid nitrogen cooling drip. Some systems may comprise an-line liquid nitrogen drip for initial cool down via an inlet at funnel 12. Some systems may comprise a heat exchange of liquid coolant (40) into the hot coffee brewer's (2) fresh water supply for efficiency of transferring heat from cooled coffee in coffee flow assembly (9) back to coffee brewer 2.

Accordingly, a flash brewer may be manufactured by operatively connecting a coolant delivery device to an insulated container. It is further appreciated that a collection container may be operatively connected to an insulated container. In some embodiment, a circulation pump may be operatively connected to an insulated container.

Using the system embodiments described above, coffee may be chilled in a very short amount of time. It is appreciated that coffee may be introduced into a coffee flow assembly of a system. It is appreciated that hot brewed coffee may be introduced into a coffee flow assembly of a system according to some embodiments. In some embodiments coffee may be passed through a coffee flow assembly of a system according to some embodiments. In some embodiments hot brewed coffee may be passed through a coffee flow assembly of a system. The chilled coffee may be collected after the coffee has passed through a coffee flow assembly of a system. It is appreciated that in some embodiments, hot brewed coffee at or about 200 degrees F. temperature is chilled to about 33 degrees F.

It is appreciated that the embodiments described herein preserves the volatile aromatics in coffee. It is further appreciated that the embodiments described herein may protect the coffee from oxidation. In some embodiment, adding an argon flush to a brewing cycle protects the coffee from being oxidized. It is appreciated that in some embodiments a nitrogen flush may be added to the brewing cycle to prevent coffee oxidation.

Referring now to FIGS. 2 and 3 the chilling container in accordance with some embodiments are shown. FIGS. 2 and 3 depict reverse flow of liquid 40 to and from the insulated container 1 as well as reverse flow of the coolant to and from the cooling flow assembly 8. Details and parts are as described for FIG. 1. Arrows pointing outwards of the fifth tubing 15 and towards the second tubing 16 indicate the flow path of a coolant within the interior of the insulated container 1 through the cooling flow assembly 8. In this embodiment, the flow-path of the coolant within cooling flow assembly is upwards. Arrows pointing towards the sixth tubing 34 and outwards of the eighth tubing 37 indicate circulation of liquid 40 within the interior of the insulated container 1 and flow path through the circulation pump 4 (not shown). In the exemplary embodiment schematically depicted in FIG. 2, the lid 10 comprises a plurality of hinges 39 attached to its upper surface so that the lid 10 can be partially opened without lifting it entirely from the insulated container 1. The insulated container may also comprise one or a plurality of handles 42.

FIG. 3 schematically depicts an exemplary embodiment of an insulated container 1. Details and parts are as described for FIG. 1. Arrows pointing outwards of the sixth tubing 16 and towards the first tubing 15 indicate the flow path of a coolant within the interior of the insulated container 1 through the cooling flow assembly 8. In this embodiment, the flow-path of the coolant within cooling flow assembly is downwards. Arrows pointing outwards of the sixth tubing 34 and towards the eighth tubing 37 indicate circulation of liquid 40 within the interior of the insulated container 1 and flow path through the circulation pump 4 (not shown). In the exemplary embodiment schematically depicted in FIG. 2, the lid 10 comprises a plurality of hinges 39 attached to its upper surface so that the lid 10 can be partially opened without lifting it entirely from the insulated container 1.

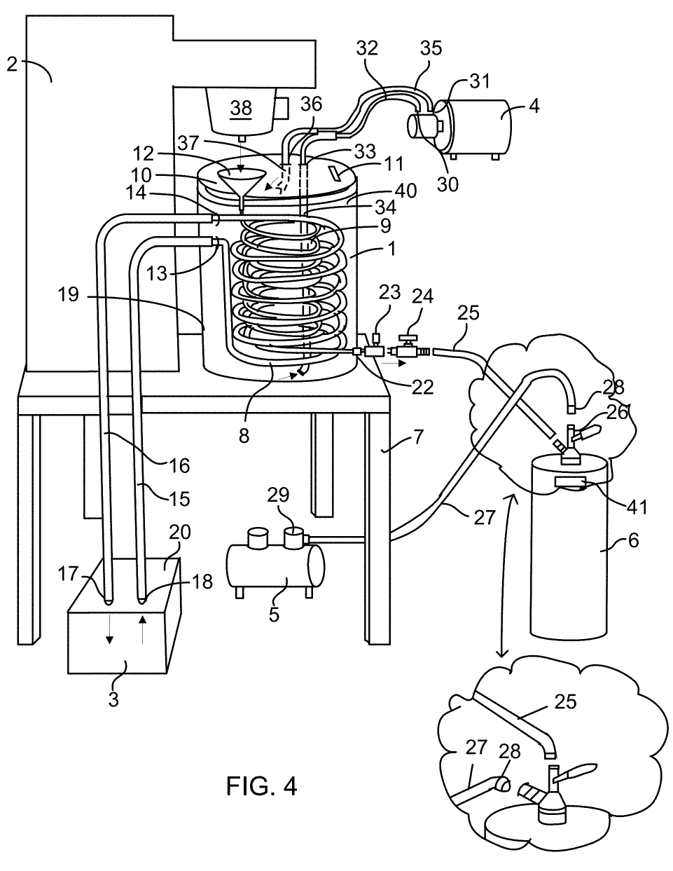

Referring now to FIG. 4, another exemplary embodiment of a flash brewer in accordance with some embodiments is shown. It is similar to the embodiment schematically depicted in FIG. 1 and the parts are as described for FIG. 1. As indicated in FIG. 4, the operative connection of third tubing 25 to the collection container 6 and that of fourth tubing 27 to the collection container 6 can be arranged so that third tubing 25 operatively connects to the upper protrusion of dual port tank coupler 26 and the fourth tubing 27 operatively connects to lower protrusion of the dual post tank coupler 26.

Referring now to FIGS. 5A and 5B, a flash brewer with frame-and-plate heat exchange device in accordance with some embodiments is shown. The flash brewer, as described in FIGS. 5A and 5B, operates similar to that of FIG. 1 except that instead of using an insulated container 1 to facilitate heat exchange, a frame-and-plate heat exchange device 3a is used. It is appreciated that the frame-and plate heat exchange device 3a is operatively connected to the hot coffee brewer 2, to a glycol chiller 3, and to a collection container 6. In this exemplary embodiment, coffee flow is from brewer basket 38 into funnel 12, then passing through a frame-and-plate heat exchange device 3a, into tubing 25 and collected in collection container 6.

The frame-and-plate heat exchange device 3a may include a first plurality of plates that houses and facilitates the flow of coolant. The frame-and-plate heat exchange device 3a may also include a second plurality of plates that houses and facilitates the flow of coffee. The first plurality of plates and the second plurality of plates are within a close proximity to one another in order to facilitate heat transfer between the hot coffee and the cooler coolant. The frame-and-plate heat exchange device 3a in fact increases the surface area used for heat exchange in order to speed up the cooling process. In some embodiments, the first plurality of plates and the second plurality of plates are interposed. For example, a plate housing and facilitating the flow of coffee may be sandwiched between two plates that houses and facilitates the flow of coolant, thereby increasing the surface area for heat exchange. In some embodiments, each plate that houses and facilitates the flow of coffee is sandwiched between two plates that house and facilitate the flow of coolant.

It is appreciated that in some embodiments, the first and the second plates of the frame-and-plate heat exchange device 3a receive the hot coffee and the cool coolant from the funnel 12 and the cooling delivery device 3 respectively. Subsequent plates within the first plurality of plates and the second plurality of plates receive their respective coffee and the coolant from previous plates within the frame-and-plate heat exchange device 3a. Coffee and coolant, therefore, make their way one plate at a time until their last respective plates where coffee is output to the collection container 6 via tubing 25 and where now warmer coolant is recirculated back to the cooling delivery device 3 to be cooled again before recirculating back into the frame-and-plate heat exchange device 3a. It is appreciated that the temperature of the coffee flowing into the frame-and-plate heat exchange device 3a is greater than the temperature of the coffee flowing out into the collection container 6. Furthermore, it is appreciated that the temperature of the coolant flowing into the frame-and-plate heat exchange device 3a is lower than the temperature of the coolant flowing out and into the cooling delivery device 3. In other words, the coolant becomes warmer due to heat exchange with hot coffee and hot coffee becomes cooler. It is further appreciated that in some embodiments, a single pass through (e.g., coffee flowing through from the first plate of entry of the frame-and-plate heat exchange device 3a to its last plate only once) the frame-and-plate heat exchange device 3a chills the coffee flowing through, thereby chilling the coffee in a span of seconds or a few minutes instead of hours in conventional systems.

According to some embodiments, each plate may include its own inlet from the funnel 12 and outlet connecting to tubing 25. In other words, the inlet of coffee from funnel 12 branches out to each plate used to facilitate the flow of coffee and the inlet of coolant from the cooling delivery device 3 branches out to each plate used to facilitate the flow of coolant. Similarly, the outlet for each plate used to facilitate the flow coffee are aggregated and output via tubing 25 to the collection container 6. Similarly, the outlet for each plate used to facilitate the flow of coolant are aggregated and recirculated back to the cooling delivery device 3, via a single connection, to be chilled.

Referring now to FIG. 5B, another embodiment for the flash brewer with frame-and-plate heat exchange device 3a is shown. The embodiment of FIG. 5B is substantially similar to that of FIG. 5A. However, in this embodiment, the warm coolant is circulated to another frame-and-plate heat exchange 3b device instead of being recirculated back to the cooling delivery device 3. For example, in this embodiment, the warm coolant is output via the coolant outlet 14 and into the inlet 18′ of the frame-and-plate heat exchange 3b device. The frame-and-plate heat exchange 3b device also receives water at room temperature via its water inlet 12′. The warm coolant is therefore used to heat the water as the coolant and water go through the frame-and-plate heat exchange 3b device, one plate at the time (similar to frame-and-plate heat exchange 3a device). The heated water is output via the outlet 25′ and input into the hot coffee brewer 2, thereby recycling heat and reducing the amount power is required for brewing coffee. The now cooler coolant is output via outlet 17′ and into the cooling delivery device 3 to be further chilled. It is appreciated that the coolant temperature at inlet 18′ is higher than the coolant temperature at outlet 17′. In other words, due to heat transfer between the coolant and water, the coolant transfers its heat to water that can later be used to brew coffee in the hot coffee brewer 2, thereby reducing the power required to heat the water, and the coolant is now cooler when it is supplied to the cooling delivery device 3, therefore requiring less power to chill the coolant.

FIG. 6A schematically depicts frame-and plate heat exchange devices. Referring now to FIG. 6B, a frame-and-plate heat exchange device 3a in accordance with some embodiments is shown. Plates 610, 620, 630, and 640 are shown. Plates 610 and 630 receive hot coffee via their respective inlet connections 612 and 632. Plates 620 and 640 receive chilled coolant via their respective inlet connections 624 and 644. Plates 620 and 640 are in close proximity to plates 610 and 630 to facilitate heat exchange between them. As such, heat is transferred from plates 610 and 630 to plates 620 and 640. Thus, coffee within plates 610 and 630 are chilled while the coolant within plates 620 and 640 heat up. The chilled coffee is output via outlets 614 and 634 while warm coolant is output via outlets 622 and 642. The chilled coffee may be collected at the collection container 6 and the warm coolant may be recirculated back according to the embodiments described in FIGS. 5A and 5B.

It is appreciated that use of four plates within the frame-and-plate heat exchange 3a device is for illustration purposes and should not be construed as limiting the scope of the embodiments. For example, any number of plates, e.g., 5 plates, 6 plates, etc., may be used. Moreover, it is appreciated that alternating the plates for facilitating the flow of coffee and coolant is exemplary and should not be construed as limiting the scope of the embodiments. For example, two plates facilitating the flow of coffee may be adjacent to one another and sandwiched between plates facilitating the flow of coolant.

Referring now to FIG. 6C, a frame-and-plate heat exchange 3a device in accordance with some embodiments is shown. It is appreciated that the embodiment illustrated is similar to that of FIG. 6B and operates substantially similar to FIG. 6B except that coffee flows from one plate to another plate and that coolant flows from one plate to another plate. For example, plate 610 may receive the brewed coffee via inlet 616 and cools the brewed coffee because of heat exchange with plate 620. The cooler brewed coffee flows out of plate 610 via the outlet 618 and into plate 630 via the inlet 636. Coffee that flows in plate 630 is further cooled down due to heat exchange with plates 620 and/or 640 or both. The chilled coffee is then output via the outlet 638 and collected by the collection container 6.

In contrast, plate 640 receives the coolant via its inlet 646 from the cooling delivery device 3. The coolant cools the plate 640 which in turn cools the plate 630 due to heat exchange. The coolant that is now at a higher temperature in comparison to when it entered the plate 640 and is output via the outlet 648 into plate 620 via the inlet 626. The coolant in plate 620 similarly cools plates 610 and/or 630 or both due to heat exchange. The coolant that is now at a higher temperature in comparison to when it entered the plate 620 and when it entered plate 640 is output via the outlet 628. The coolant is recirculated according to FIG. 5A or 5B.

It is appreciated that use of four plates within the frame-and-plate heat exchange 3a device is for illustration purposes and should not be construed as limiting the scope of the embodiments. For example, any number of plates, e.g., 5 plates, 6 plates, etc., may be used. Moreover, it is appreciated that alternating the plates for facilitating the flow of coffee and coolant is exemplary and should not be construed as limiting the scope of the embodiments. For example, two plates facilitating the flow of coffee may be adjacent to one another and sandwiched between plates facilitating the flow of coolant. Moreover, it is appreciated that although connections between two plates are shown to be from the bottom of the plates, the connections may be through the plates (e.g., horizontally). As such, the embodiments described herein and their connections thereto should not be construed as limiting the scope of the embodiments. It is further appreciated that the coolant and/or coffee may be circulated within the frame-and-plate heat exchange 3a device via their respective pump.

Referring now to FIG. 6D, a gravity based heat exchange device in accordance with some embodiments is shown. In this embodiment, heat exchange plates 680 are stacked vertically on top of one another. For example, plates 691, 692, . . . , 698 are stacked on top of one another. It is appreciated that the base of the plates 691, 693, 695, and 697 are angled to enable brewed coffee to flow downward because of gravity. Plates 692, 694, 696, and 698 are positioned vertically adjacent to the plates 691, 693, 395, and 697, to enable coolant to flow through them and to cool the plates 691, 693, 395, and 697 where brewed coffee is flowing.

In some embodiments, brewed coffee may be input to the top plate 691 via coffee inlet 682 and flows downward due to its base being angled. Plate 691 is cooled because of heat exchange with plate 692 where coolant is flowing. Brewed coffee that has been cooled is output from plate 691 to plate 693 (connection between the two plates are not shown). The cooled brewed coffee within plate 693 is further cooled due to heat exchange with plates 692 and 694 were coolant is flowing. Brewed coffee that is now at a lower temperature flows downward due to its base being angled similar to plate 691. It is appreciated that process continues between all the plates until the brewed coffee reaches the last plate 697 where it is further cooled using plate 698 and output via coffee outlet 684 to a collection container 6.

It is appreciated that coolant flows through plates 698, 696, 694, and 692 respectively (connections between the plates are now shown for simplicity). For example, coolant is received at plate 698 via coolant inlet 686 from the cooling delivery device 3. The coolant flows through plates 698, 696, 694, and 692 and cools each plate respectively. As such, each of the plates 698, 696, 694, and 692 enables heat transfer from plates 697, 695, 693, and 691 respectively, thereby cooling the brewed coffee. It is appreciated that unlike brewed coffee that flows downward due to gravity, the coolant is supplied from the bottom plate 698 and pumped all the way through each plate until it reaches plate 692 before it is output via coolant outlet 688. It is appreciated that the coolant becomes warmer in each subsequent plate due to heat exchange with plates where brewed coffee is flowing. In contrast, it is appreciated that the brewed coffee becomes cooler in each subsequent plate due to heat exchange with plates where coolant is flowing.

It is appreciated that in some embodiments, a single pass through (e.g., coffee flowing through from the first plate 691 of entry to its last plate 697 only once) the heat exchange device chills the coffee flowing through, thereby chilling the coffee in a span of seconds or a few minutes instead of hours in conventional systems. It is appreciated that any of the heat exchange devices, as shown in FIGS. 6A-6D may be used, to cool the brewed coffee in accordance with embodiments described in FIGS. 5A or 5B.

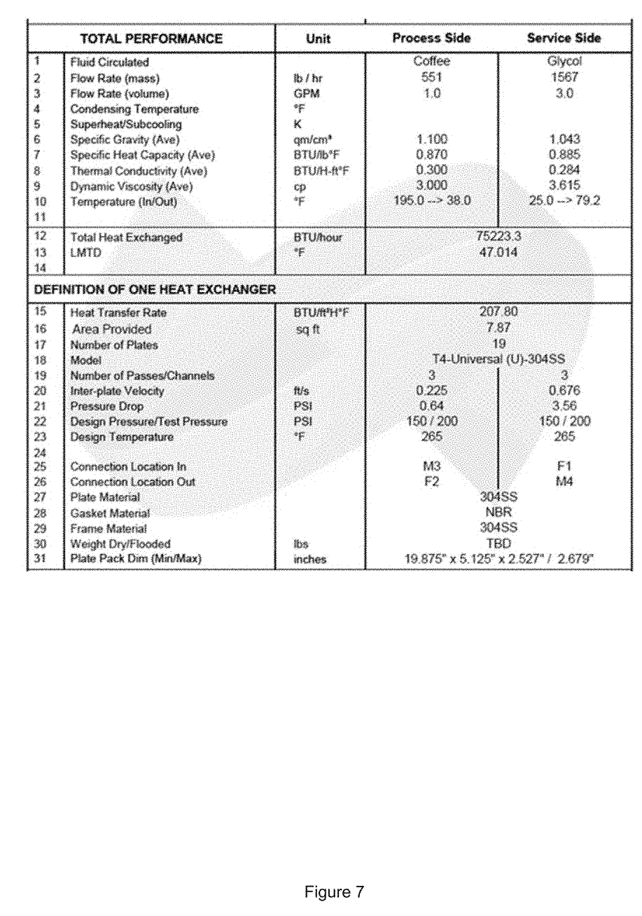

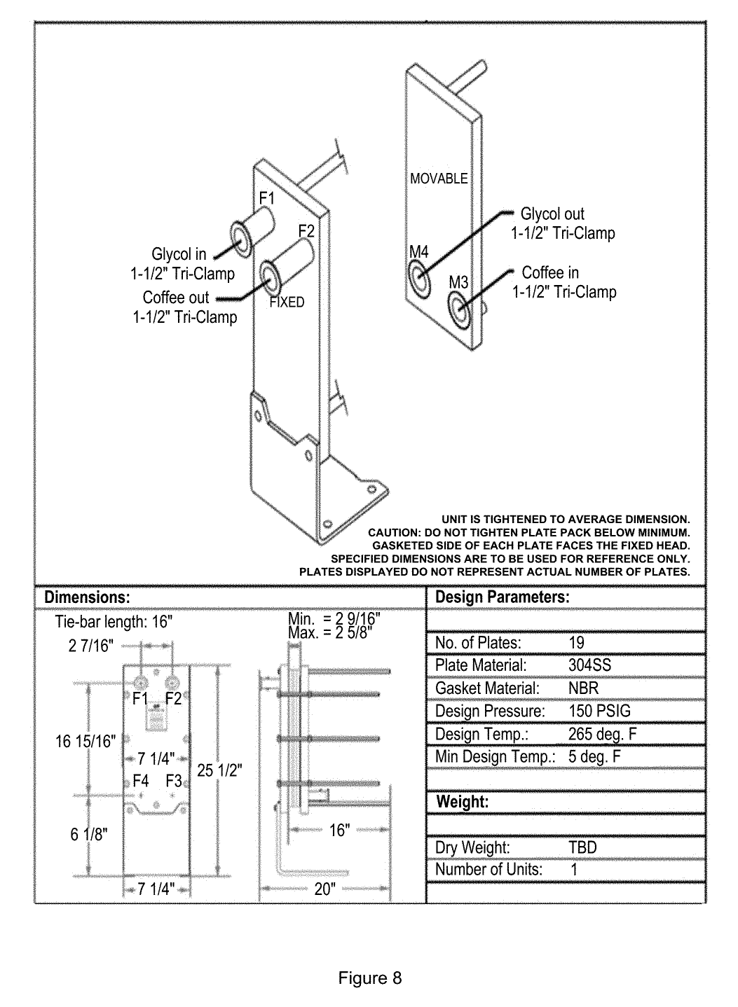

FIG. 7 depicts functional and performance parameters and technical data of a frame-and plate heat exchange device in accordance with some embodiments. FIG. 8 depicts additional design details and dimensions of a frame-and plate heat exchange device in accordance with some embodiments.

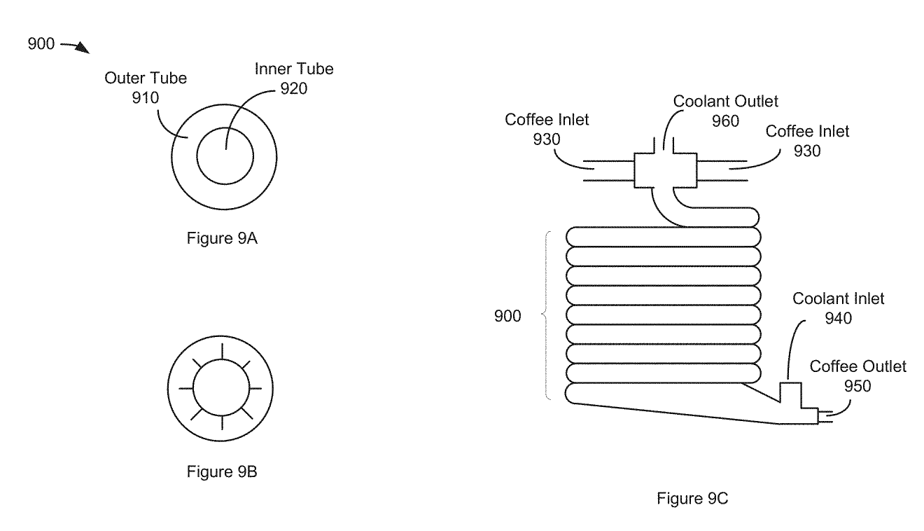

Referring now to FIGS. 9A-9C, a heat exchange device in accordance with alternative embodiments is shown. More specifically referring to FIG. 9A, two concentric tubes 910 and 920 are shown. The inner tube 920 has a smaller diameter in comparison to the outer tube 910. It is appreciated that brewed coffee may flow in the inner tube 920 which is surrounded with the outer tube 910 that may facilitate the flow of coolant. Thus, the brewed coffee cools as it flows through the inner tube 920. It is appreciated that in some embodiments, the outer tube 920 may flow the brewed coffee and the inner tube 910 may flow the coolant. It is appreciated that the heat exchange device 900 may be used instead of using frame-and-heat exchange device or in combination with it in order to cool the brewed coffee. Referring now to FIG. 9B, an alternative embodiment for facilitating heat exchange is shown. Similar to FIG. 9A, two concentric tubes are used but the tubes are finned tubes.

Referring now to FIG. 9C, coffee inlet 930 is used to supply the brewed coffee. The heat exchange device 900 as described with respect to FIGS. 9A and 9B may be used. The brewed coffee flows through the heat exchange device. Coolant is supplied via coolant inlet 940 and flows through the heat exchange device 900. Thus, the brewed coffee is cooled and finally output via coffee outlet 950 where it may be collected and stored by the collection container 6. As the brewed coffee is cooled when it flows through the heat exchange device 900, the coolant is heated. Coolant that is now at a higher temperature in comparison to when it was supplied via the coolant inlet 940, is output via the coolant outlet 960. The higher temperature coolant may be recirculated according to the embodiments described in FIG. 5A or 5B. It is appreciated that in some embodiments, a single pass through the heat exchange device 900 chills the coffee flowing through, thereby chilling the coffee in a span of seconds or a few minutes instead of hours in conventional systems.

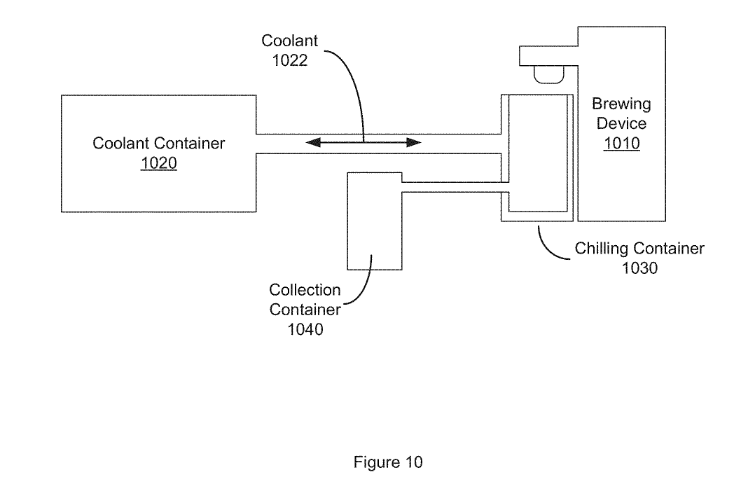

Referring now to FIG. 10, a flash brewer in accordance with alternative embodiments is shown. The brewing device 1010 is similar to the hot coffee brewer 2 and brews coffee. The brewed coffee is supplied to the chilling container 1030 where brewed coffee is chilled. The coolant container 1020 stores coolant, e.g., liquid nitrogen, etc. Coolant may be supplied via a pump/connection (not shown) to the chilling container 1030. It is appreciated that the chilling container 1030 may have an inner reservoir and an outer reservoir. It is appreciated that the brewed coffee is collected in the inner reservoir and the coolant is supplied to the outer reservoir that surrounds the inner reservoir, thereby cooling the brewed coffee. The chilled coffee may then be output to the collection container 1040, that may be similar to the collection container 6.

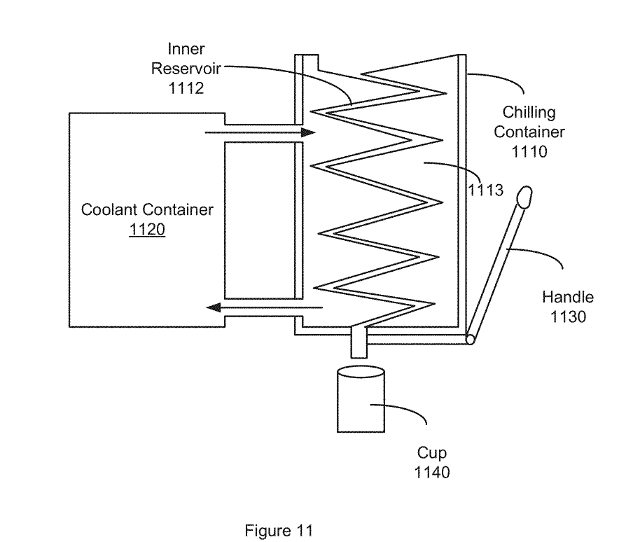

Referring now to FIG. 11, a single cup flash brewer in accordance with some embodiments is shown. It is appreciated that in this embodiment the chilling container 1110 may be shaped to have an inner reservoir having a liquid pathway 1112 and an outer reservoir 1113. The liquid pathway 1112 receives the hot liquid, e.g., brewed coffee. The outer reservoir 1113 receives the coolant, e.g., liquid nitrogen, from the coolant container 1120. The outer reservoir 1113 surrounds the inner reservoir 1112. As such, heat transfers from the brewed coffee to the coolant in the outer reservoir 1113, as coffee flows through the inner reservoir 1112. Accordingly, the brewed coffee is chilled as it flows through the inner reservoir 1112. It is appreciated that in some embodiments, a sensor and temperature control unit (not shown) may be used to determine when the desired chilling temperature for the brewed coffee is reached. Once the desired temperature is reached, the handle 1130 may be operated to open the nozzle output of the chilling container 1110 such that chilled coffee can be collected in the cup 1140. It is appreciated that temperature control and sensors may be used to determine when the coolant in the outer reservoir 1113 has reached an unacceptable temperature, at which point, the coolant is circulated back to the coolant container 1120 to be further chilled to the desired temperature.

It is appreciated that variations, changes, modifications and substitution of equivalents on those embodiments described will become apparent to those of ordinary skill in the art upon reading the foregoing description. While each of the elements is described herein as containing multiple embodiments, it should be understood that, unless indicated otherwise, each of the embodiments of a given element is capable of being used with each of the embodiments of the other elements and each such use is intended to form a distinct embodiment.

As can be appreciated from the disclosure above, the present invention has a wide variety of applications.

For convenience individual components of a flash brewer of the present invention, a system of the present invention or of a device of the present invention are listed below with their corresponding numerical numbers as used herein

1. Insulated container

2. Hot coffee brewer

3. Coolant delivery device (e.g., Glycol chiller or frame-and plate heat exchange)

4. Circulation pump

5. Vacuum pump

6. Collection container

7. Support stand

8. Cooling flow assembly (e.g., for glycol)

9. Coffee flow assembly (coffee; also for tea)

10. Lid

11. Handle or plurality of handles on lid

12. Funnel

13. Coolant inlet

14. Coolant outlet

15. First tubing (coolant out from glycol chiller into insulated container)

16. Second tubing (coolant out from insulated container into glycol chiller)

17. Glycol chiller outlet

18. Glycol chiller inlet

19. Wall of the insulated container

20. Wall of glycol chiller

21. Coffee inlet

22. Coffee outlet

23. Needle valve

24. Ball valve

25. Third tubing (from insulated container to collection container)

26. Dual port tank coupler

27. Fourth tubing (from collection container to vacuum pump)

28. Gas port

29. Vacuum pump port

30. Circulation pump inlet

31. Circulation pump outlet

32. Fifth tubing (from circulation pump to lid)

33. First tubing inlet

34. Sixth tubing (from lid into interior of insulated container [liquid circulation]

35. Seventh tubing (from lid to circulation pump)

36. Second tubing inlet

37. Eighth tubing (from interior of insulated container to lid)

38. Brew basket

39. Plurality of hinges

40. Liquid in insulated container

41. Handle or plurality of handles on collection container

42. Handle or plurality of handles on insulated container

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A system for chilling liquid comprising:
an insulated container configured to thermally insulate interior of the insulated container from an exterior environment of the insulated container;
a liquid inlet coupled to the insulated container, wherein the liquid inlet is configured to receive a liquid to be chilled;
a liquid flow assembly housed within the insulated container, wherein the liquid flow assembly is configured to receive the liquid to be chilled from the liquid inlet and to flow the liquid to be chilled;
a cooling assembly housed within the insulated container, wherein the cooling assembly is configured to flow coolant composition within the cooling assembly, wherein the cooling assembly is thermally coupled to the liquid flow assembly facilitating a heat exchange between the liquid to be chilled and the coolant composition; and
a liquid outlet coupled to the insulated container, wherein the liquid outlet is configured to output the chilled liquid to the exterior environment of the insulated container.

2. The system of claim 1, wherein the liquid to be chilled is chilled within a single pass through the liquid flow assembly.

3. The system of claim 1 further comprising:
a coolant delivery device configured to cool the coolant composition after being heated due to heat exchange with the liquid to be chilled, wherein the coolant delivery device is selected from a group comprising of glycol chiller, a device configured to house dry ice, a liquid nitrogen cooling device, a coil ice bath, a coil glycol bath, a frame-and-plate heat exchange device, and a heat transfer water reclamation device.

4. The system of claim 3 further comprising:
a cooling assembly inlet coupled to the cooling assembly, wherein the cooling assembly inlet is configure to receive the coolant composition from the coolant delivery device external to the insulated container; and
a cooling assembly outlet coupled to the cooling assembly, wherein the cooling assembly outlet is configured to output the coolant composition to the coolant delivery device, wherein the coolant composition at the cooling assembly inlet is at a lower temperature than the cooling assembly outlet.

5. The system of claim 1 further comprising:
a liquid inlet coupled to the insulated container configured to receive another liquid that maintains substantially constant temperature within the insulated container, wherein the liquid flow assembly and the cooling assembly are submerged within the another liquid; and
a liquid outlet coupled to the insulated container configured to output the another liquid, wherein the another liquid output from the liquid outlet is heated or cooled to the substantially constant temperature before the liquid inlet receives the another liquid that is at substantially constant temperature.

6. The system of claim 5 further comprising:
a stirrer configured to stir the another liquid within the insulated container to maintain a homogeneous temperature throughout the insulated container.

7. The system of claim 1, wherein the liquid to be chilled is coffee and wherein the coolant composition is selected from a group comprising of a glycol compound, a glycol ether, glycerin, liquid nitrogen, a freon refrigerant, and a chlorofluorocarbon compound.

8. The system of claim 1 further comprising:
a collection container coupled to the liquid outlet, wherein the collection container is configured to collect the chilled liquid, wherein the collection container is further configured to create a vacuum for enabling the liquid to be chilled to flow through the liquid flow assembly.

9. The system of claim 1, wherein the liquid flow assembly is shaped as a coil, and wherein the cooling assembly is shaped as a coil, and wherein the liquid flow assembly is positioned in close proximity to the cooling assembly to facilitate heat exchange between the liquid to be chilled and the coolant composition.

10. A frame-and-plate heat exchange device comprising:
a first plurality of plates configured to receive a liquid to be chilled, wherein the liquid to be chilled flows through the first plurality of plates; and
a second plurality of plates configured to receive a coolant composition and wherein the coolant composition flows through the second plurality of plates, wherein the second plurality of plates is positioned in close proximity with the first plurality of plates and further configured to facilitate heat transfer from the liquid to be chilled within the first plurality of plates to the coolant composition within the second plurality of plates.

11. The frame-and-plate heat exchange device of claim 10 further comprising:
a liquid inlet coupled to the first plurality of plates, wherein the liquid inlet is configured to receive the liquid to be chilled;
a liquid outlet coupled to the first plurality of plates, wherein the liquid outlet is configured to output the chilled liquid to the exterior environment of the frame-and-plate heat exchange device;
a cooling assembly inlet coupled to the second plurality of plates, wherein the cooling assembly inlet is configure to receive the coolant composition from a coolant delivery device external to the frame-and-plate heat exchange device; and
a cooling assembly outlet coupled to the second plurality of plates, wherein the cooling assembly outlet is configured to output the coolant composition to the coolant delivery device, wherein the coolant composition at the cooling assembly inlet is at a lower temperature than the cooling assembly outlet.

12. The frame-and-plate heat exchange device of claim 11 further comprising:
the coolant delivery device configured to cool the coolant composition after being heated due to heat exchange with the liquid to be chilled, wherein the coolant delivery device is selected from a group comprising of glycol chiller, a device configured to house dry ice, a liquid nitrogen cooling device, a coil ice bath, a coil glycol bath, and a heat transfer water reclamation device.

13. The frame-and-plate heat exchange device of claim 10, wherein the liquid to be chilled is coffee and wherein the coolant composition is selected from a group comprising of a glycol compound, a glycol ether, glycerin, liquid nitrogen, a freon refrigerant, and a chlorofluorocarbon compound.

14. The frame-and-plate heat exchange device of claim 10, wherein the liquid to be chilled is chilled within a single pass through the first plurality of plates.

15. The frame-and-plate heat exchange device of claim 10 further comprising:
a collection container coupled to output of the first plurality of plates, wherein the collection container is configured to collect the chilled liquid, wherein the collection container is further configured to create a vacuum for enabling the liquid to be chilled to flow through the liquid flow assembly.

16. The frame-and-plate heat exchange device of claim 10, wherein the first plurality of plates is interposed with the second plurality of plates.

17. The frame-and-plate heat exchange device of claim 10, wherein each plate of the first plurality of plates is angled to facilitate flow of the liquid to be chilled via gravity in a single pass.

18. A system for chilling liquid comprising:
a liquid flow assembly configured to receive liquid to be chilled and further configure to facilitate flow the liquid to be chilled within the liquid flow assembly;
a liquid inlet coupled to the liquid flow assembly, wherein the liquid inlet is configured to receive the liquid to be chilled;
a cooling assembly configured to flow coolant composition within the cooling assembly, wherein the cooling assembly is thermally coupled to the liquid flow assembly facilitating a heat exchange between the liquid to be chilled and the coolant composition; and
a liquid outlet coupled to the liquid flow assembly, wherein the liquid outlet is configured to output the chilled liquid to an exterior environment of the liquid flow assembly.

19. The system of claim 18, wherein the liquid flow assembly and the cooling assembly is a frame-and-plate heat exchange device comprising:
a first plurality of plates configured to receive the liquid to be chilled, wherein the liquid to be chilled flows through the first plurality of plates; and
a second plurality of plates configured to receive the coolant composition and wherein the coolant composition flows through the second plurality of plates, wherein the second plurality of plates is positioned in close proximity with the first plurality of plates and further configured to facilitate heat transfer from the liquid to be chilled within the first plurality of plates to the coolant composition within the second plurality of plates.

20. The system for chilling liquid of claim 19 further comprising:
a collection container coupled to output of the first plurality of plates, wherein the collection container is configured to collect the chilled liquid, wherein the collection container is further configured to create a vacuum for enabling the liquid to be chilled to flow through the liquid flow assembly.

21. The system for chilling liquid of claim 19, wherein the first plurality of plates is interposed with the second plurality of plates.

22. The system for chilling liquid of claim 19, wherein each plate of the first plurality of plates is angled to facilitate flow of the liquid to be chilled via gravity in a single pass.

23. The system for chilling liquid of claim 19, wherein the liquid to be chilled is coffee and wherein the system further comprises:
another frame-and-plate heat exchange device, wherein the another frame-and-plate heat exchange device is configured to receive the coolant composition from the second plurality of plates of the frame-and-plate heat exchange device wherein the received coolant composition from the frame-and-plate heat exchange device is at a higher temperature in comparison to the coolant composition being received by the second plurality of plates of the frame-and-plate heat exchange device, and wherein the another frame-and-plate heat exchange device is configured to receive water at room temperature and wherein the another frame-and-plate heat exchange device is configured facilitate heat transfer from the coolant composition to the water and wherein the heated water is used to brew coffee.

24. The system for chilling liquid of claim 18 further comprising:
a cooling assembly inlet configure to receive the coolant composition from a coolant delivery device external to the cooling assembly; and
a cooling assembly outlet configured to output the coolant composition to the coolant delivery device, wherein the coolant composition at the cooling assembly inlet is at a lower temperature than the cooling assembly outlet.

25. The system for chilling liquid of claim 24 further comprising:
the coolant delivery device configured to cool the coolant composition after being heated due to heat exchange with the liquid to be chilled, wherein the coolant delivery device is selected from a group comprising of glycol chiller, a device configured to house dry ice, a liquid nitrogen cooling device, a coil ice bath, a coil glycol bath, and a heat transfer water reclamation device.

26. The system for chilling liquid of claim 18, wherein the liquid to be chilled is coffee and wherein the coolant composition is selected from a group comprising of a glycol compound, a glycol ether, glycerin, liquid nitrogen, a freon refrigerant, and a chlorofluorocarbon compound.

27. The system for chilling liquid of claim 18, wherein the liquid to be chilled is chilled within a single pass through the liquid flow assembly.

28. The system for chilling liquid of claim 18, wherein the liquid flow assembly and the cooling assembly are two concentric tubes, wherein one concentric tube facilitates flow of the liquid to be chilled and wherein another concentric tube facilitates flow of the coolant composition, and wherein the two concentric tubes facilitate heat exchange between the liquid to be chilled and the coolant composition.
